(19) United States
(12) Patent Application Publication
(10) Pub. No.: US 2026/0265846 A1
(43) Pub. Date: Sep. 10, 2026

(54) METHODS FOR REDUCING METAL OXIDES WITH AMMONIA GAS

(71) Applicant: Trustees of Tufts College, Medford, MA (US)

(72) Inventors: Luke M. Davis, Medford, MA (US); Sanya Mittal, Medford, MA (US)

(21) Appl. No.: 19/491,303

(22) PCT Filed: Jun. 12, 2024
(86) PCT No.: PCT/US2024/033612

§ 371 Date: Dec. 8, 2025

Related U.S. Application Data
(60) Provisional application No. 63/508,179, filed on Jun. 14, 2023.

(51) Int. Cl. C21B 13/00; C01B 21/06; C22B 5/12; C22B 15/00; C22B 19/20; C22B 23/02; C22B 25/02; C22B 34/36

(52) U.S. Cl. CPC C21B 13/0073; C01B 21/0622; C22B 5/12; C22B 15/0026; C22B 19/20; C22B 23/021; C22B 25/02; C22B 34/36

(57) ABSTRACT

Disclosed herein are methods for reducing metal oxides without the production of CO₂. The present disclosure describes a method for reducing a metal oxide, the method comprising contacting a metal oxide with a reducing gas comprising primarily ammonia for a reduction time at a reduction temperature, wherein ammonia contacting the metal oxide reduces the metal oxide.

### CROSS-REFERENCE TO RELATED APPLICATIONS

This application claims benefit of priority to U.S. Patent Application Ser. No. 63/508,179, filed Jun. 14, 2023. The contents of which is incorporated by reference in its entirety.

### FIELD OF INVENTION

The present disclosure discloses a method to reduce metal oxides without the production of CO₂ gas as a byproduct. More particularly, methods for reducing metal oxides with ammonia gas are disclosed.

### BACKGROUND OF THE INVENTION

Reduction of metal oxides, like iron oxide, are commonly performed using fossil fuels as the reducing feedstock. In blast-furnace ironmaking, which comprises ca. 90% of global ironmaking, coke is typically used as the reducing agent; CO₂ gas is a chemical byproduct of this method. In direct reduction ironmaking, a mixture of hydrogen and carbon monoxide (synthesis gas or “syngas”) is used; water and CO₂ gas are the chemical byproducts. This synthesis gas is made from one or more fossil fuels, most commonly natural gas. In the production of many other metals from their metal oxide ores, the metal oxide is reduced at some point with a fossil fuel-based reducing agent, often coke, with CO₂ gas as a chemical byproduct. These metals include cobalt, nickel, tin, tungsten, and zinc. As a result, there is a need for methods of reducing metal oxides by means that are cost- and energy-efficient, and that do not facilitate the production of CO₂.

### BRIEF SUMMARY OF THE INVENTION

Methods for reducing metal oxides with ammonia gas are disclosed. The method may comprise contacting a metal oxide with a reducing gas comprising primarily ammonia for a reduction time at a reduction temperature, wherein ammonia contacting the metal oxide reduces the metal oxide. In some embodiments, a purge gas is introduced for one or more intervals during the reduction time.

Another aspect of the technology provides for a method for reducing metal oxides comprising heating the interior of a reactor to the reduction temperature prior to contacting the metal oxide with the reducing gas for the reduction time at the reduction temperature and introducing a cooling gas into the interior of the reactor after contacting a metal oxide with the reducing gas for the reduction time at the reduction temperature.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows moles of ammonia required to form 2 Fe from Fe₂O₃ at equilibrium vs. temperature (dashed line), with byproduct gas amounts (solid lines).

FIG. 2. Process and instrumentation diagram of our chemical reactor. Gases are delivered through stainless steel tubing by mass flow controllers (MFCs) to the reactor, a quartz tube in a tube furnace. Most seals are face seals (VCR) using stainless steel gaskets, except the quartz-to-metal flanges, which use silicone or EPDM O-rings.

FIG. 3. Comparison of pXRD patterns for Methods A and B, showing higher cooling gas flow rate leads to iron and lower cooling gas flow rate leads to iron nitride. In both methods, NH₃ was delivered at 120 sccm at 700° C. for 10 minutes. In Method A (top), heating/cooling Ar was delivered at 120 sccm. In Method B (bottom), heating/cooling Ar was delivered at 40 sccm. The stick plots below the data show the diffraction locations and relative intensities for α-Fe (black) and γ′-Fe₄N (grey, peaks denoted with star) reference patterns.

FIG. 4. Powder X-ray diffraction pattern for a sample produced by Method C1, showing a mixture of iron with a smaller amount of iron nitride.

FIG. 5. Comparison of pXRD patterns for Methods C2 and C3, showing the effect of holding for an additional five minutes at temperature under Ar before starting the cooling process. Top (C2): NH₃ was delivered at 40 sccm for 10 minutes at 700° C. For the bottom pattern (C3), the procedure is the same except that the sample is held under Ar at 700° C. for 5 min after NH₃ flow ends but before the cooling process begins.

FIG. 6. Comparison of pXRD patterns for Method C4, showing higher temperature leads to a decrease in nitride. In both methods, NH₃ was delivered at 40 sccm for 10 minutes at temperature. Reduction temperatures: top, 700° C.; bottom, 800° C. For both reactions, the heating/cooling Ar was delivered at 40 sccm.

FIG. 7. Comparison of pXRD patterns for Methods A and D, showing that cooling under NH₃ leads to iron nitride with enhanced nitrogen content. In both methods, NH₃ was delivered at 120 sccm at 700° C. for 10 minutes. In Method A (top), heating/cooling Ar was delivered at 120 sccm. In Method D (bottom), the heating gas was Ar at 120 sccm, and the cooling gas was NH₃ at 120 sccm.

FIG. 8. Powder X-ray diffraction pattern for a sample produced by Method E, showing pure iron produced in 1 minute at 1000° C. with 80 sccm NH₃.

FIG. 9. Powder X-ray diffraction patterns for a sample produced by Method F, showing pure iron across all four boats. The patterns are plotted with boat 1, at the reactor inlet, at the top of the plot.

FIG. 10. Powder X-ray diffraction patterns for a sample produced by Method G, showing pure iron in boats 1 and 2, and iron plus FeO in boats 3 and 4. The patterns are plotted with boat 1, at the reactor inlet, at the top of the plot.

FIG. 11. Powder X-ray diffraction pattern for a sample produced by Method E, variant 2, showing pure iron produced at 900° C. in the front and back of the boat.

FIG. 12. Powder X-ray diffraction pattern for a sample produced by Method H, showing pure iron.

FIG. 13. Powder X-ray diffraction pattern for a sample produced by Method I, showing iron.

FIG. 14. Powder X-ray diffraction pattern for taconite ore from Minnesota, showing the majority of the crystalline material in the ore pellet is hematite, Fe₂O₃.

FIG. 15. EDS spectrum for taconite ore from Minnesota, showing the typical ore pellet components Mg, Ca, Al, and Si along with iron oxide.

FIG. 16. Powder X-ray diffraction pattern for a sample produced by Method J, showing the iron in a chunk of iron ore can be reduced fully to iron metal (the oxides of Mg, Ca, Al, and Si are still present, see Tables 13-14).

FIG. 17. Powder X-ray diffraction pattern for a sample produced by Method K, showing a mixture of iron and iron nitride produced at 600° C. from a powdered iron ore pellet.

FIG. 18. Powder X-ray diffraction pattern for a sample produced by Method L, showing iron nitride with a small amount of iron produced at 600° C. from a powdered iron ore pellet.

FIG. 19. Powder X-ray diffraction pattern for a sample produced by Method M, showing iron produced from a whole BF-grade ore pellet at 1000° C.

FIG. 20. Powder X-ray diffraction pattern for a sample produced by Method N, showing iron nitride with some magnetite and silica, produced at 700° C. from magnetite ore concentrate.

FIG. 21. Powder X-ray diffraction pattern for a sample produced by Method O, showing a mixture of iron and iron nitride with some silica, produced at 600° C. from magnetite ore concentrate.

FIG. 22. Powder X-ray diffraction pattern for a sample produced by Method P, showing iron with some iron nitride and silica, produced at 1000° C. from magnetite ore concentrate.

FIG. 23. Powder X-ray diffraction pattern for a sample produced by Method Q, showing iron can be made at 700° C. when heating and cooling under nitrogen.

FIG. 24. Powder X-ray diffraction pattern for a sample produced by Method R, showing copper(II) oxide can be reduced to copper by ammonia.

FIG. 25. Powder X-ray diffraction pattern for a sample produced by Method S, showing nickel(II) oxide can be reduced to nickel by ammonia at 500° C.

FIG. 26. Powder X-ray diffraction pattern for a sample produced by Method S, Variant 2, showing nickel(II) oxide can be reduced to nickel by ammonia at 400° C.

FIG. 27. Powder X-ray diffraction pattern for a sample produced by Method T, suggesting Co₃O₄ can be reduced to cobalt metal by NH₃.

FIG. 28. Powder X-ray diffraction pattern for a sample produced by Method U, showing tin(IV) oxide can be reduced to tin by ammonia. The diffraction pattern shows the beads of crystalline tin are not randomly oriented (intensities deviate from the reference pattern for tin powder, although the diffraction positions match appropriately).

FIG. 29. Powder X-ray diffraction pattern for a sample produced by Method V at 1000° C., showing tungsten(VI) oxide can be reduced to tungsten by NH₃.

FIG. 30. Powder X-ray diffraction pattern for samples produced by Method X, starting with different oxides at 1000° C. Top: starting oxide is FeO. Middle: starting oxide is Fe₃O₄. Bottom: starting oxide is Fe₂O₃.

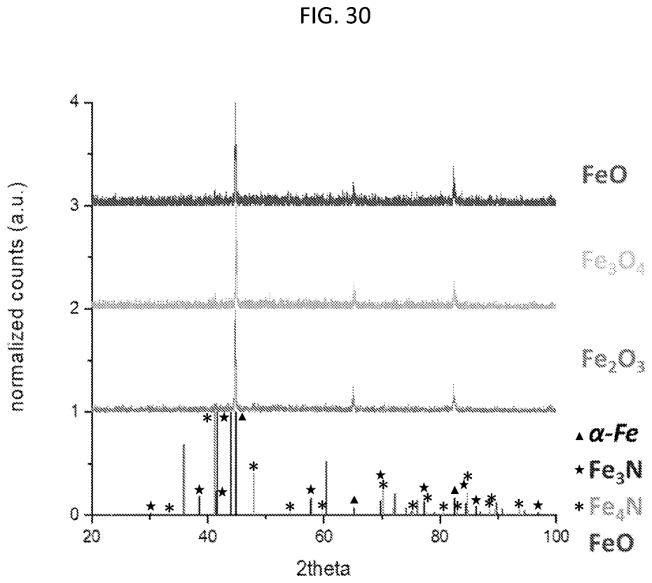

FIG. 31. Powder X-ray diffraction pattern for a sample produced by Method Y, showing ε-Fe₃N produced from Fe₃O₄ at 700° C.

FIG. 32. Powder X-ray diffraction pattern for a sample produced by Method Z, showing a mixture of Fe and γ′-Fe₄N produced from FeO(OH) at 700° C.

FIG. 33. Powder X-ray diffraction pattern for a sample produced by Method α, showing ε-Fe₃N produced from FeO(OH) at 700° C.

FIG. 34. Powder X-ray diffraction pattern for a sample produced by Method β, showing ε-Fe₃N with some Fe₃O₄ produced from FeO(OH) at 600° C.

FIG. 35. Powder X-ray diffraction patterns for samples taken from the front and back of boats 1-4 for large scale reduction by Method γ with 4 pulses of NH₃ at 1000° C., separated by pulses of argon. From bottom to top, the patterns proceed from inlet to outlet. Beginning at the bottom is the front of boat 1, at the inlet end of the reactor, and the top pattern shows the back of boat 4, at the outlet end of the reactor. The front is indicated by “f” and the back by “b”. The patterns show complete reduction to iron throughout all four boats.

FIG. 36. Powder X-ray diffraction patterns for samples taken from the front and back of each boat, numbered 1-4, for large scale reduction by Method 8 with 2 pulses of NH₃ at 1000° C., separated by pulses of argon. From bottom to top, the patterns go from inlet (1) to outlet (4). The front is indicated by “f” and the back by “b”. The diffraction patterns show complete reduction to iron in boats 1 and 2, but the presence of FeO in boats 3 and 4.

FIG. 37. Powder X-ray diffraction patterns for samples taken from the front and back of each boat, numbered 1-3, for large scale reduction by Method ε with 2 pulses of NH₃ at 1000° C. From bottom to top, the patterns go from inlet (1) to outlet (3). The front is indicated by “f” and the back by “b”. The diffraction patterns show complete reduction to iron in boats 1 and 2, but the presence of FeO in boat 3.

FIG. 38. Powder X-ray diffraction patterns for a sample of iron produced from Fe₂O₃ by Method ζ with 5 pulses of NH₃ at 700° C.

FIG. 39. Powder X-ray diffraction patterns for a sample of iron nitride with some iron and some magnetite, produced from reduction of Fe₂O₃ with 11 wt. % SiO₂ by Method η at 600° C.

FIG. 40. Powder X-ray diffraction patterns for a magnetic sample of iron nitride (top) separated from silicon dioxide (bottom) with a magnet, by Method θ. A mixture of Fe₂O₃ with 10 wt. % SiO₂ was reduced with ammonia at 700° C., and then separated magnetically.

FIG. 41. Powder X-ray diffraction patterns for a sample of iron with some iron nitride, produced from BF-grade iron ore powder mixed with an additional 10 wt. % SiO₂ by Method ι at 600° C. The iron and silica were separated magnetically after reduction with ammonia.

FIG. 42. Powder X-ray diffraction patterns for a magnetic sample of iron with some iron nitride (top) separated from silicon dioxide (bottom) with a magnet, by Method κ. A mixture of 50 wt. % Fe₂O₃ and 50 wt. % SiO₂ was reduced with ammonia at 700° C., and then separated magnetically.

FIG. 43. Powder X-ray diffraction patterns for a sample produced by Method λ, showing ε-Fe₃N produced from Fe₃O₄ at 700° C. using a 3:1 mixture of ammonia: hydrogen.

FIG. 44. Powder X-ray diffraction patterns for a sample produced by Method μ, showing iron with some γ′-Fe₄N produced from Fe₂O₃ at 700° C. using a 3:1 mixture of ammonia: hydrogen.

FIG. 45. Powder X-ray diffraction patterns for a sample produced by Method ν, showing a mixture of iron and nickel produced from a mixture of Fe₂O₃ and NiO using ammonia at 700° C.

### DETAILED DESCRIPTION OF THE INVENTION

Disclosed herein are methods for reducing metal oxides without producing CO₂. The disclosed process for reducing a metal oxide to metal uses ammonia. Elevated temperatures result in higher rates of metal production and greater utilization of ammonia than any previous ammonia-based process. The metal making process has no direct CO₂ emissions.

The disclosed technology achieved rates of metal production higher than previously known ammonia-based metal making or ironmaking. The Examples demonstrate an enhanced rate of ironmaking, e.g., ca. 50× compared with the current state of the art³ and >500× compared with the previous state of the art.^{1,2} The previous state of the art reduced iron oxide (hematite, Fe₂O₃) or iron ore to iron at temperatures up to 700° C., over 2-2.5 hours. The disclosed technology can complete reduction of a similar charge of iron oxide in 1 minute at 1000° C. or a 50% smaller charge in 5 minutes at 700° C.

Several innovations led to this result. First, the reduction temperature is higher such that the thermodynamics favor iron production. Second, byproduct water within the reactor may be managed by controlling reactor temperature, metal oxide location within the reactor, gas dosing recipe, and gas flow rates. Water inhibits the reaction, and driving off the water allows us to operate under non-equilibrium conditions that further enhance the rate of reduction. Third, the Examples demonstrate the fastest rates involve heating and cooling under inert gas, which is believed to provides two benefits. The reaction is performed above the kinetic decomposition temperature of iron nitride. For example, iron nitride starts to decompose ca. 630° C., when a sample is heated at 10° C./min for thermogravimetric analysis, meaning that any iron nitride formed can decompose. Inert gas at high flow rates helps to lessen nitrogen incorporation, resulting in a more pure metal or iron product. By heating under an inert atmosphere, kinetic traps for the metal may be avoided, possibly including metal nitrides and intermediate metal oxides, such as iron nitride or ferrous oxide.

The disclosed process utilizes more of the ammonia delivered to the reactor than previously known methods. The Examples demonstrate about a ten-fold improvement over the previous record. The disclosed technology demonstrates utilization of about 56% of the ammonia, instead of only about 5% of the ammonia. Ammonia utilization is important in terms of cost and energy efficiency; higher utilization represents lower cost and higher energy efficiency.

By way of example, reduction of iron(III) oxide is an equilibrium process strongly dependent on temperature. The overall reaction is:

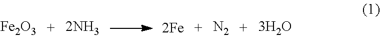

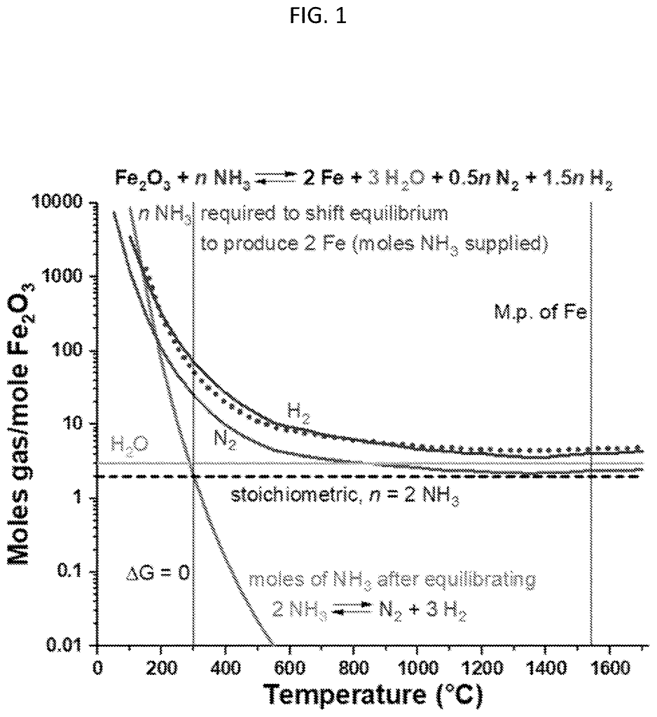

Thermodynamic calculations show that reduction of 1 mole of iron(III) oxide by 2 moles of ammonia is favorable above 300° C. However, the reaction is an equilibrium process, and shifting the heterogeneous equilibrium to produce pure iron requires 52 moles of ammonia per mole of Fe₂O₃ (FIG. 1). By raising the temperature to 700° C., just 7 moles NH₃/mole Fe₂O₃ are required for the equilibrium to favor pure iron. The minimum (4.4 mol NH₃/mol Fe₂O₃) occurs at 1350° C. At 1000° C., 5.2 mol NH₃/mol Fe₂O₃ are required at equilibrium.

The Examples demonstrate a single pass of the ammonia gas over a fixed bed of metal oxide. Recirculation of the dehydrated exhaust gases should allow for further improvement of the overall ammonia utilization.

The disclosed methods also allow for compositional control. In some instances, it may be useful to include some nitrogen in the final product. The disclosed technology can controllably introduce an amount of nitrogen in the final metal or reduced metal oxide product. For example, between 0 at. % N (e.g., pure Fe) and 25 at. % N (e.g., Fe₃N) may be achieved by changing temperature, cooling gas, gas composition, and gas flow rates. Under some conditions, the disclosed process can also rapidly and efficiently produce metal nitride (e.g., Fe₃N or Fe₄N, depending on conditions). Metal nitrides may be converted to metals under appropriate conditions. For example, iron nitride can be converted to iron by heating to a suitable temperature (e.g., 700° C.) under an inert atmosphere (e.g., argon).

The disclosed technology is scalable and transferable. The process works at several scales and with several metal oxide inputs. For example, the process can reduce hematite (Fe₂O₃), wustite (FeO), magnetite (Fe₃O₄), or goethite (FeO(OH)) as well as non-ferrous metal oxides, such as nickel oxide, cobalt oxide, tungsten oxide, tin oxide, zinc oxide, and copper oxide. The process works with fine powders or mm-scale chunks of metal oxide (simulating iron ore fines and pellets). The Examples also demonstrate that the process can be scaled up to reduce larger amounts of metal oxide. The Examples also demonstrate that the process works with magnetite concentrate, or with blast furnace grade iron ore pellets.

The Examples also show that mixtures of ammonia and hydrogen work well, in some cases allowing more complete reduction or less nitrogen incorporation than ammonia alone. These results simulate recirculation of byproduct gases because excess ammonia is decomposed on the iron surface during our reaction to nitrogen and hydrogen. This process is the reverse of the Haber-Bosch ammonia synthesis, where N₂+3 H₂→2 NH₃ over an iron catalyst. When we add an ammonia decomposition catalyst (e.g., some iron metal) to the front of the reactor, we observe complete reduction of our iron oxide charge to iron at lower temperatures. For example, at 600° C., ammonia alone produces iron nitride (mix of Fe₃N and Fe₄N), whereas ammonia and hydrogen together produce iron with some iron nitride (Fe and Fe₄N). One source of this result is the change in the nitriding potential, a process parameter that controls nitrogen incorporation into iron (and is a ratio of the partial pressures of H₂ and NH₃, K_{N}═P(NH₃)/(P(H₂)^{3/2}) during nitriding of steel.

One aspect of the present disclosure teaches a method for reducing metal oxide. During the reduction stage, a reducing gas comprising primarily ammonia is introduced into the interior of the reactor at the reduction temperature for a reduction time. The ammonia contacts the metal oxide within the reactor, thereby reducing the metal oxide.

The reducing gas introduced during the reduction stage is primarily ammonia. “Primarily ammonia” means that more than 50 mol % of the reducing gas comprises ammonia. For example, more than 50 mol %, 55 mol %, 60 mol %, 65 mol %, 70 mol %, 75 mol %, 80 mol %, 85 mol %, 90 mol %, 91 mol %, 92 mol %, 93 mol %, 94 mol %, 95 mol %, 96 mol %, 97 mol %, 98 mol %, or 99 mol % of the reducing gas may be ammonia. The reducing gas may be substantially ammonia, which refers to a reducing gas having more than 95 mol % ammonia. In some instances, the reducing gas may consist essentially of ammonia, which refers to a reducing gas having de minimis amounts of one or more additional gaseous components in addition to ammonia.

In some aspects, the reducing gas may further comprise hydrogen. In some instances, the majority of hydrogen introduced may be a recirculated byproduct. The reactor can have an ammonia decomposition catalyst, such as an iron catalyst, within the interior of a reactor, allowing for in situ hydrogen generation.

The temperature used for reduction may be between 300° C. and 1600° C. In an aspect, the temperature used for reduction is between 600° C. and 1000° C. In some aspects, the temperature used for reduction may be at least about 300° C., 350° C., 400° C., 450° C., 500° C., 550° C., 600° C., 650° C., 700° C., 750° C., 800° C., 850° C., 900° C., 950° C., or 1000° C. In some aspects, the temperature used for reduction may be at most about 1000° C., 1050° C., 1100° C., 1150° C., 1200° C., 1250° C., 1300° C., 1350° C., 1400° C., 1450° C., 1500° C., 1550° C., or 1600° C.

The metal oxide can be selected from iron oxide, nickel oxide, cobalt oxide, tungsten oxide, tin oxide, zinc oxide, copper oxide, and any combination thereof. When the metal oxide is an iron oxide, it may have the chemical formula Fe₂O₃, Fe₃O₄, FeO, FeO(OH), or any combination thereof. The presently disclosed methods are amenable to compositions comprising the metal oxide and one or more additional chemical components.

Metal oxides within ores may be reduced by the presently disclosed technology. Ores generally comprise the metal oxide to be reduced and one or more additional chemical components. Chemical components that are generally unwanted or undesirable may be referred to as gangue. The methods disclosed allow for reduction of the metal oxide in the presence of gangue. In some instances, more than 1.5%, 2%, 4.5%, 5%, 10%, 20%, 30%, 40%, or 50% of the ore or mixture of metal oxide and gangue by weight can be gangue. In some instances, between 1.5% and 50%, 2% and 50%, 4.5% and 50%, 5% and 50%, 10% and 50%, 20% and 50%, 30% and 50%, or 40% and 50% of the ore or mixture of metal oxide and gangue by weight can be gangue. The methods may optionally include steps to separating at least a portion of the gangue after reduction. In some instances, more than 10%, 20%, 30%, 40%, 50%, 60%, 70%, 80%, 90%, or 95% of the gangue may be separated from the metal oxide or reduced metal oxide product. These methods may be suitable for metal extraction from ore tailings or fines, which are left over after primary ore beneficiation processes.

Gangue may be separated from reduced metal oxide by various methods. One suitable method employs magnets to separate magnetic metal oxide products, such as iron, from non-magnetic gangue, such as silicon dioxide.

The reduction time may be selected to achieve at least 50% conversion of the metal oxide to metal. The reduction time may be selected to achieve at least 55%, 60%, 65%, 70%, 75%, 80%, 85%, 90%, 91%, 92%, 93%, 94%, 95%, 96%, 97%, 98%, or 99% conversion of the metal oxide to metal. In some instances, the reduction time is selected to convert essentially all of the metal oxide to metal, which refers to an undetectable amount of metal oxide starting material.

Metal oxides having smaller dimensions are reduced more quickly and with higher utilization of ammonia that larger dimensions. As a result, the methods disclosed herein may be advantageously used to reduce ore or metal oxide particles or fines. Thus the methods allow for reduction of a metal oxide in material that could be considered waste material if not pelletized prior to reduction. This can result in an expansion of the materials that can be reduced in the disclosed methods and/or omission of a pelletization step to transform fines into larger pellets through agglomeration or induration.

The amount of ammonia contacted with the metal oxide may be selected to be effective in reducing at least 50% of the metal oxide to metal. The amount of ammonia may be selected to achieve at least 55%, 60%, 65%, 70%, 75%, 80%, 85%, 90%, 91%, 92%, 93%, 94%, 95%, 96%, 97%, 98%, or 99% conversion of the metal oxide to metal. In some instances, the amount of ammonia is selected to convert essentially all of the metal oxide to metal, which refers to an undetectable amount of metal oxide starting material. The amount of ammonia contacted with the metal oxide may be between 2 and 50 moles, 2 and 45 moles, 2 and 40 moles, 2 and 35 moles, 2 and 30 moles, 2 and 25 moles, 2 and 20 moles, 2 and 15 moles, 2 and 10 moles of ammonia per mole of metal oxide. In some instances, the ammonia utilization may be greater than 10%, 15%, 20%, 25%, 30%, 35%, 40%, 45%, or 50%.

The reduction time may be between 1 min and 24 hours, 1 min and 18 hours, 1 min and 12 hours, 1 min and 6 hours, 1 min and 4 hours, 1 min and 2 hours, 1 min and 1 hour, 1 min and 30 min, or 1 min and 15 min. In some aspects, the reduction time may be less than or equal to 1 min, 2 min, 3 min, 4 min, 5 min, 6 min, 7 min, 8 min, 9 min, 10 min, 11 min, 12 min, 13 min, 14 min, 15 min, 30 mins, 1 hours, 2 hours, 4 hours, 6 hours, 12 hours, 18 hours, or 24 hours. In some aspects, the reaction time may be at most 15 min, 16 min, 17 min, 18 min, 19 min, 20 min, 21 min, 22 min, 23 min, 24 min, 25 min, 26 min, 27 min, 28 min, 29 min, or 30 min.

In some aspects, a purge gas may be introduced for one or more intervals during the reduction stage. Such methods may be beneficial to increase ammonia utilization and/or allow for larger charges of metal oxide to be reduced. Use of the purge gas during the reduction stage may provide one or more benefits. The purge gas may be useful for controlling the vapor pressure of water within the reactor chamber and allow for higher conversion of the metal oxide to metal. Moreover, use of the purge gas may be useful in ameliorating the endothermicity of ammonia-based reduction by allowing the metal oxide to maintain a temperature closer to the desired reduction temperature. Three factors work together to maintain the temperature without changing the overall endothermicity of the reaction. First, the intermittent reduction, spreading the reduction out over longer times means that the cooling per unit time is smaller. The heat flux from the furnace can keep up better. Second, the purge interval allows the charge some time to reheat. Third, the purge gas itself can carry some heat to the metal oxide. Accordingly, the purge gas may be introduced at a temperature approximately equal to the desired reduction temperature or above.

In instances where a purge gas is introduced for one or more intervals during the reduction stage, the number of intervals may be selected to increase conversion of metal oxide to metal for a given amount of ammonia. The number of intervals during the reduction stage may be 1, 2, 3, 4, 5, 6, 7, 8, 9, 10, or any other appropriate number of intervals. The number or duration of the intervals may be selected prior to initiating the reduction stage or selected based on one or more parameters or measurements determined during the reduction stage. For example, an interval may be initiated or extended when a particular parameter or measurement is determined. Intervals may be initiated periodically or not. The duration of the interval time may be between 1 min and 30 min or between 1 min and 15 min. In some aspects, the duration of the interval may be less than or equal to 1 min, 2 min, 3 min, 4 min, 5 min, 6 min, 7 min, 8 min, 9 min, 10 min, 11 min, 12 min, 13 min, 14 min, or 15 min. In some aspects, the duration of the interval may be at most 15 min, 16 min, 17 min, 18 min, 19 min, 20 min, 21 min, 22 min, 23 min, 24 min, 25 min, 26 min, 27 min, 28 min, 29 min, or 30 min. The purge gas may be selected from inert gases such as argon and nitrogen.

The disclosed methods can prepare pure metals, including iron, tungsten, tin, cobalt, copper, and nickel, and mixtures of these metals, such as mixtures of iron and nickel. Zinc can also be prepared, although the temperatures required vaporize zinc metal, and the metal is oxidized by byproduct water to re-form zinc oxide. Thermodynamic calculations show additional metals should be reducible with ammonia, including cadmium, mercury, molybdenum, and lead. Reaction conditions may be selected based on the starting metal oxide to be reduced. The examples demonstrate complete reduction for iron, tungsten, tin, cobalt, nickel, and copper. Cobalt, nickel, and copper can be produced at 500° C.; these reactions are thermodynamically favorable at room temperature. Tungsten can be produced at 1000° C. Tin can be produced at 800° C., in the presence of an ammonia decomposition catalyst (e.g., iron powder).

In some embodiments, the method may be characterized by three stages: a heating stage, a reduction stage, and a cooling stage. During the heating stage, the interior of a reactor having a metal oxide therein is heated to a reduction temperature under an inert atmosphere. Suitably an inert gas may be flowed into the reaction chamber during heating. The reactor may be heated by about 10 to 30° C./min, or any range therebetween.

During the cooling stage, a cooling gas is introduced into the interior of the reactor. During the cooling stage the temperature of the interior of the reactor is lowered to a desirable final temperature, which may be room temperature. The reactor may be cooled by about 10 to 60° C./min, or any range therebetween.

The reducing gas may be introduced at a rate between 40 sccm and 4,000,000 slm, or any range therebetween, depending on the amount of and composition metal oxide.

During the heating stage, inert gas may be introduced into the reactor during heating at a rate of between 40 sccm and 4,000,000 slm, or any amount therebetween. The inert gas may comprise argon, nitrogen, or combinations thereof. More than 50 mol %, 55 mol %, 60 mol %, 65 mol %, 70 mol %, 75 mol %, 80%, 85%, 90 mol %, 95 mol %, 96 mol %, 97 mol %, 98 mol %, or 99 mol % of the gas introduced during the heating stage may be the inert gas. In some instances, the gas introduced during the heating stage consists essentially of inert gas, i.e., the gas has a de minimis amounts of one or more additional gaseous components in addition to the inert gas.

During the cooling stage, the cooling gas may be introduced at a rate of 40 sccm and 20,000,000 slm, or any range therebetween. The cooling gas may comprise an inert gas (e.g., argon, nitrogen), ammonia, or combinations thereof. More than 50 mol %, 55 mol %, 60 mol %, 65 mol %, 70 mol %, 75 mol %, 80%, 85%, 90 mol %, 95 mol %, 96 mol %, 97 mol %, 98 mol %, or 99 mol % of the gas introduced during the cooling stage may be an inert gas, ammonia, or any combination thereof. In some instances, the gas introduced during the cooling stage consists essentially of inert gas and/or ammonia, i.e., the gas has a de minimis amounts of one or more additional gaseous components in addition to the inert gas or ammonia.

During reduction, water generated during reduction can hinder overall metal oxide reduction. In some instances, the amount of water present in the reactor during or at the conclusion of the reduction time is less than 1.50, 1.25, 1.00, 0.75, or 0.50 moles water per mole of metal. In some instances the amount of water present in the reactor during or at the conclusion of the reduction time is less than 220, 200, 180, 160, 140, or 120 Torr when reduction is performed at 760 Torr (i.e., 1 atm). The purge gas may be used to suitably control the amount of water present during reduction.

When a purge gas is utilized, the purge gas may be introduced at a rate between 40 sccm and 20,000,000 slm, or any range therebetween, depending on the amount of and composition of metal oxide.

The disclosed technology may be scaled up from grams of metal oxide per charge to thousands of metric tons per charge by utilizing higher gas flow rates, and/or longer reaction times. The Examples demonstrated that the iron(III) charge can be scaled up at least five time using the same reduction time when the ammonia delivery rate is scaled up proportionally. The Examples also demonstrated that a lower flow rate of ammonia for a longer reduction time can perform equivalently to a higher flow rate of ammonia for a shorter reduction time. The tradeoff is not strictly linear in moles of ammonia used, but the Examples suggest that either longer reaction time or higher flow rate can be effective for larger charges. Moreover, when metal oxide with decreased porosity compared with powder is used, the Examples also demonstrate that increasing the reaction time is effective in reducing the metal oxide.

The disclosed methods may be performed at industrial scales by utilizing ironmaking furnaces or kilns. For example, rotary kilns, blast furnaces, shaft furnaces, and the like are compatible with the disclosed methods because direct reduction, e.g., with syngas, is accomplished with existing infrastructure.

The Examples demonstrate a batch process, but the disclosed methodology may be performed continuously. The disclosed technology may be accomplished continuously by heating the metal oxide in a heating zone, transferring the heated metal oxide to a reduction zone where the heated metal oxide contacts ammonia for an appropriate duration; and then transferring the reduced metal oxide to a cooling zone to lower the temperature of the reduced metal oxide.

Managing byproduct water may be challenging at larger scales, but alternating pulses of ammonia and inert gas provides a ready solution for managing the partial pressure of water within the rector. Alternatively, a larger reactor volume would produce a lower partial pressure of water for the same reduction rates.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” “primarily,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus≤10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### Exemplary Embodiments

Embodiment 1. A method for reducing a metal oxide, the method comprising contacting a metal oxide with a reducing gas comprising primarily ammonia for a reduction time at a reduction temperature, wherein ammonia contacting the metal oxide reduces the metal oxide.
Embodiment 2. The method of embodiment 1, wherein a purge gas is introduced for one or more intervals during the reduction time.
Embodiment 3. The method of embodiment 2, wherein the purge gas comprises argon or nitrogen.
Embodiment 4. The method of any one of embodiments 1-3, wherein the amount of ammonia contacted with the metal oxide is effective in reducing at least 50% of the metal oxide to metal or metal nitride.
Embodiment 5 The method of any one of embodiments 1-4, wherein the amount of ammonia contacted with the metal oxide is between 2 and 50 moles of ammonia per mole of metal oxide.
Embodiment 6 The method of any one of embodiments 1-5, wherein the reducing gas is substantially ammonia.
Embodiment 7 The method of any one of embodiments 1-6, wherein the reducing gas further comprises hydrogen.
Embodiment 8. The method of any one of embodiments 1-7, wherein the reduction temperature is between 300° C. and 1600° C.
Embodiment 9. The method of any one of embodiments 1-8, wherein the reduction temperature is between 600° C. and 1000° C.
Embodiment 10. The method of any one of embodiments 1-9, wherein the metal oxide is selected from an iron oxide, nickel oxide, cobalt oxide, tungsten oxide, tin oxide, zinc oxide, copper oxide, and any combination thereof.
Embodiment 11. The method of any one of embodiments 1-10, wherein the metal oxide is an iron oxide.
Embodiment 12. The method of any one of embodiments 1-11, wherein the metal oxide is Fe₂O₃, Fe₃O₄, FeO, FeO(OH), or any combination thereof.
Embodiment 13. The method of any one of embodiments 1-12, wherein an ore comprising the metal oxide is reduced.
Embodiment 14. The method of embodiment 13, wherein the ore comprises hematite, wustite, magnetite, or goethite.
Embodiment 15. The method of embodiments 13 or 14, wherein the ore further comprises more than 10% gangue by weight.
Embodiment 16. The method of any one of embodiments 13-15, wherein the gangue comprises silicon dioxide or aluminum oxide.
Embodiment 17. The method of any one of embodiments 13-16 further comprising separating the reduced metal oxide from gangue.
Embodiment 18. The method of embodiment 17, wherein the reduced metal oxide is magnetic, wherein at least a portion of the gangue is non-magnetic, and wherein the reduced metal oxide is magnetically separated from the gangue.
Embodiment 19. The method of any one of embodiments 1-18, wherein the reduction time is between 1 min and 24 hours.
Embodiment 20. The method of embodiment 19, wherein the reduction time is between 1 min and 60 min.
Embodiment 21. The method of any one of embodiments 1-20, further comprising heating the interior of a reactor to the reduction temperature prior to contacting the metal oxide with the reducing gas for the reduction time at the reduction temperature, and introducing a cooling gas into the interior of the reactor after contacting a metal oxide with the reducing gas for the reduction time at the reduction temperature.
Embodiment 22. The method of embodiment 21, wherein the reactor has an ammonia decomposition catalyst therein and introducing the reducing gas into the interior of the reactor generates hydrogen in situ.
Embodiment 23. The method of any one of embodiments 21-22, wherein an inert gas is introduced into the interior of the reactor during heating of the reactor.
Embodiment 24. The method of embodiment 23, wherein the inert gas comprises argon or nitrogen.
Embodiment 25. The method of any one of embodiments 21-24, wherein the cooling gas comprises argon or nitrogen.
Embodiment 26. The method of any one of embodiments 21-25, wherein the reducing gas is introduced into the interior of the reactor at a rate of between 40 sccm and 4,000,000 slm.
Embodiment 27. The method of any one of embodiments 21-26, wherein the cooling gas is introduced at a rate of between 40 sccm and 20,000,000 slm.
Embodiment 28. The method of any one of embodiments 23-27, wherein the inert gas is introduced into the reactor during heating at a rate of between 40 sccm and 4,000,000 slm.
Embodiment 29. The method of any one of embodiments 21-28, wherein the purge gas is introduced into the reactor a rate of between 40 sccm and 20,000,000 slm.
Embodiment 30. The method of any one of embodiments 21-29, wherein the amount of water within the interior of the reactor during or at the conclusion of the reduction time is less than 1.5 moles per mole of metal.
Embodiment 31. The method of any one of embodiments 21-30, wherein the partial pressure of water within the interior of the reactor is less than 220 Torr when reduction is performed at 760 Torr.

### EXAMPLES

### Experimental

Chemicals and supplies. Iron(III) oxide powder (Alfa Aesar, 35 μm aerodynamic particle size, 99.9% purity), chunks of iron(III) oxide (Alfa Aesar, 3-12 mm, 99.85+% purity), and anhydrous ammonia (Millipore Sigma, lecture bottle, ≥99.98% purity) were used as received. Sample iron ore pellets derived from Minnesota taconite were purchased via eBay. Copper(II) oxide (Aldrich, >99.99% purity), cobalt(II, III) oxide powder (Alfa Aesar, 99.9985% purity), nickel(II) oxide powder (Alfa Aesar, 99.998% purity), tin(IV) oxide powder (Alfa Aesar, 99.996% purity), molybdenum(VI) oxide (Alfa Aesar, 99.998% purity), and tungsten(VI) oxide (Alfa Aesar, 99.998% purity) were used as received. A tablet of zinc(II) oxide (Alfa Aesar, 10-12 mm diameter and 4-5 mm thick, 99.9% purity) was ground with a mortar and pestle before use. Argon and nitrogen gases were purchased at ultrahigh purity (Airgas, UHP grade, ≥99.999%) and used without further purification. Hydrogen was generated on demand with a commercial electrolyzer (Parker, H2PEM-100).

Quartz boats (17 mm wide×100 mm long, MTI Corp.) were scored and cleaved to remove the front and rear lips of the boat. The remaining boat used for a typical reaction was ca. 70 mm long.

Characterization. The solid reaction products were characterized by powder X-ray diffraction (pXRD), scanning electron microscopy (SEM), and energy dispersive X-ray spectroscopy (EDS). Some reaction products were characterized for nitrogen content by combustion analysis (performed by the University of Illinois School of Chemical Sciences Microanalysis Laboratory).

X-ray diffractograms were recorded using a Bruker D2 PHASER X-ray diffractometer using Cu Kα radiation (λ=1.542 Å) and a θ-2θ scan. Samples were ground with a mortar and pestle before being loaded onto a Si crystal zero diffraction plate and placed on the sample holder for measurement. For a typical analysis, portions of the sample were selected from the inlet end and outlet end of the quartz boat. XRD data are plotted above standard, labelled reference patterns.

Field-emission scanning electron microscopy (FESEM) was performed with an AMRAY 1845 FE-SEM with SEMView8000, refurbished by SEMTech Solutions (North Billerica, MA). Sections of the sample were selected from the inlet end, outlet end, middle, and bottom of the charge contained in the quartz boat. Samples were mounted on aluminum stubs with carbon adhesives prior to loading and imaging.

Energy-dispersive X-ray spectroscopy (EDS) was performed using the SEM beam and a Thermo Scientific Noran System 6 detector. The EDS detector is mounted normal to the imaging beam, so the sample stage was tilted 20° toward the detector during analysis to increase the X-ray counts arriving at the detector. Samples were analyzed at 1000× magnification, a 15 kV imaging voltage, and a working distance of 18-25 mm. EDS maps were collected for at least two locations from each section of the charge, providing at least 6 data points for each sample.

General procedure. In a typical reduction experiment, the metal oxide charge (most commonly iron(III) oxide) is massed and transferred to a quartz boat. The boat is loaded into the quartz tube of the chemical reactor and placed approximately in the center of the furnace heating zone. The ends of the quartz tube are then connected via the MTI vacuum sealing assemblies to the gas delivery and exhaust scrubbing systems. The reactor is purged with heating gas (typically argon or nitrogen) for at least 5 minutes, to ensure that air has been purged from the reactor and the entire volume of the reactor (the largest volume, the quartz tube, is ca. 200 mL) has been filled with the heating gas (typically argon or nitrogen).

To conduct the experiment, the temperature in the tube furnace is ramped to the desired reaction temperature at a rate of ca. 20° C./min under a flow of gas, typically argon or nitrogen, delivered by the mass flow controller (MFC). Once at temperature, the heating gas is turned off and the reducing gas is turned on, with the flow rate controlled by its own MFC. The furnace is held at temperature for a set time under a flow of reducing gas, typically ammonia, with the hold time and flow rate being process parameters that can help control the product identity. After the hold time has elapsed, the cooling gas flow (typically argon or nitrogen) is turned on and the NH₃ flow is shut off. The furnace is cooled by being held open until the furnace temperature drops below 600° C., at which point an aluminum block is used to prop the furnace open until it is cool enough for the tube to be removed from the furnace (<200° C.). After removal, the tube is cooled to room temperature before the cooling gas flow is turned off and the quartz boat is removed. The product is massed and then sampled for analysis by SEM/EDS and pXRD.

Various hold times, metal oxides, and gas flows have been explored at temperatures ranging from 500 to 1000° C. In the following descriptions, iron(III) oxide powder (Alfa Aesar, 35 μm aerodynamic particle size, 99.9% purity) was used as the metal oxide unless otherwise specified.

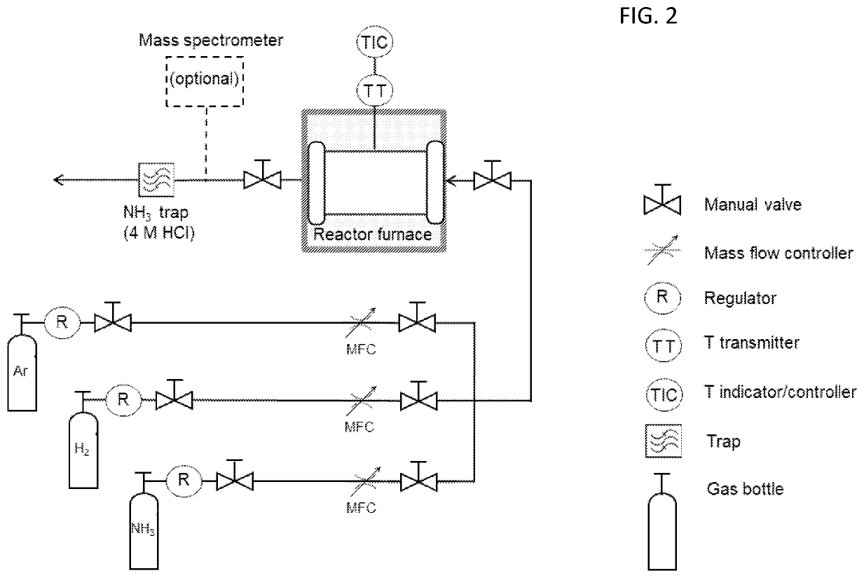

Reactor. An exemplary reactor system utilized to reduce metal oxides in the above Examples is shown in FIG. 2. All reactions were conducted in a custom-built chemical reactor used as a hot-walled, fixed-bed reactor. A piping and instrumentation diagram for the reactor is shown in FIG. 2. The reactor was constructed and operated inside of a walk-in fume hood.

The reaction zone of our reactor is constructed from a quartz tube (25 mm OD, 20.5 mm ID, 600 mm length; MTI Corp.), placed in a Lindberg Blue M Mini-Mite tube furnace (TF55035A-1, multi-segment programmable, 1100° C. maximum temperature). The quartz tube and its connecting flanges are supported by adjustable clamps (MTI Corp.). Gases are supplied to the reaction zone through a manifold constructed from 316L stainless steel flexible tubing by mass flow controllers (MFCs; Aalborg, GFC series, stainless steel with VCR connections). This manifold is connected to the quartz tube using a silicone O-ring based quartz-to-steel vacuum-tight flange adapter (vacuum sealing assembly, MTI Corp.; or KF to quick coupling adapter, High Vac Depot). Three individual branches of the manifold combine at a cross; between the MFCs and the vacuum flange, all connections are VCR-type metal face seals made using stainless steel gaskets. Each MFC can be isolated from the reactor with a manual shut-off valve.

Each gas was delivered to its mass flow controller independently. Copper tubing (0.25″ OD) connects the two-stage gas regulator on the argon cylinder to the Ar MFC; a Swagelok ferrule-to-VCR adapter was used to connect the copper tubing to the MFC. In some cases, nitrogen was used in place of argon; the gas bottle was exchanged in those cases, but the gas plumbing remained the same. The ammonia lecture bottle regulator was connected via 316L stainless steel braided flexible Swagelok® tubing with VCR fittings to the NH₃ MFC. When hydrogen was used, it was delivered through copper tubing (0.125″ OD), through a Swagelok ferrule-to-VCR adapter, to the H₂ MFC; when not in use, that line was typically capped at the VCR cross. Gases leaving the reactor were bubbled through acid solution to capture unreacted ammonia before the exhaust gas was released to the fume hood. The outlet vacuum sealing flange (MTI Corp, or High Vac Depot) was connected by EPDM tubing to a gas washing bottle. Optionally, the reactor was connected to a turbo-pumped mass spectrometer (residual gas analyzer, Inficon Transpector 2.0, TSPTT200, 0-200 amu) before the washing bottle via a tee, a manual valve, a leak valve (Swagelok), 316L stainless steel braided flexible Swagelok® tubing with VCR fittings, and a second leak valve (Duniway). The washing bottle was filled with a solution of 4 M hydrochloric acid, and the gas diffuser was inserted to just cover the top of the diffuser with solution; this arrangement could remove any unreacted ammonia from the gas stream while also regulating the gas pressure and limiting diffusion of air into the reactor.

### Example 1. Reduction of Iron(III) Oxide at 700° C.

Depending on the heating and cooling gas identity, and the flow rate of each gas, the final product is pure iron (α-Fe), pure iron nitride (γ′-FeAN), a mixture of these products, or a mixture of iron nitrides (ε-Fe₃N and γ′-Fe₄N).

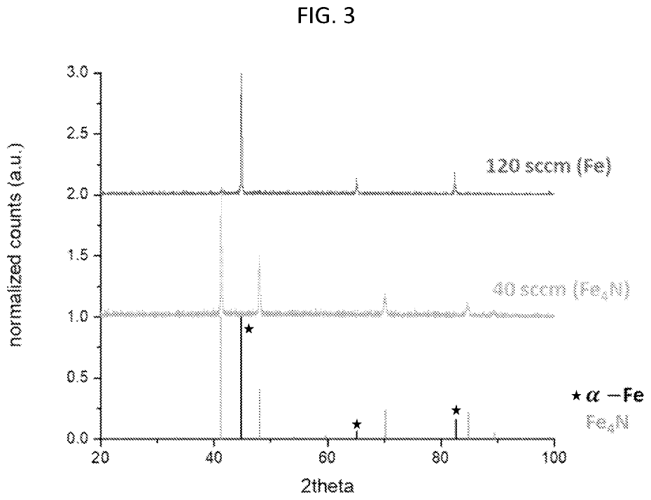

Method A, producing pure iron. The quartz boat was charged with 0.173 g (1.08 mmol) of iron(III) oxide and loaded into the reactor. The reactor was purged with argon at 120 standard cubic centimeters per minute (sccm; 1 sccm≈1 mL/min) for 5 minutes. The reactor was then heated under 120 sccm of Ar at 20° C./min to 700° C., at which temperature the Ar flow was stopped and a flow of 120 sccm of NH₃ was introduced. After flowing at this rate for 10 minutes, the ammonia flow was stopped and the Ar flow was resumed at 120 sccm. The reactor was cooled at ca. 40° C./min. Yield: 0.121 g (expected for pure Fe: 0.121 g). The pXRD pattern in FIG. 3 (top) shows the product is pure α-Fe. EDS (Table 1) provides a composition of 99-100 at. % Fe, 0 at. % O, and 0-1 at. % N.

In this reaction, ~1200 mL NH₃ (53.6 mmol) were delivered; 2.16 mmol were needed for complete reduction of Fe₂O₃ to 2 Fe, meaning 4% of the NH₃ delivered was used to produce iron.

TABLE 1

| Reactor | Iron at. % | Oxygen at. % | Nitrogen at. % |
|---|---|---|---|
| Position | (Fe Kα) | (O Kα) | (N Kα) |
| Front 1 | 100 ± 1 | 0 ± 1 | 0 ± 1 |
| Front 2 | 100 ± 1 | 0 ± 1 | 0 ± 1 |
| Back 1 | 100 ± 1 | 0 ± 1 | 0 ± 1 |
| Back 2 | 99 ± 1 | 0 ± 1 | 1 ± 1 |
| Bottom 1 | 100 ± 1 | 0 ± 1 | 0 ± 1 |
| Bottom 2 | 99 ± 1 | 0 ± 1 | 1 ± 1 |

Method B, producing iron nitride, γ′-Fe₄N. The quartz boat was charged with 0.161 g (1.01 mmol) of iron(III) oxide and loaded into the reactor. The reactor was purged with argon at 40 sccm for 10 minutes. The reactor was then heated under 40 sccm Ar at 20° C./min to 700° C., at which temperature the Ar flow was stopped and a flow of 120 sccm of NH₃ was introduced. After flowing at this rate for 10 minutes, the ammonia flow was stopped and the Ar flow was resumed at 40 sccm. The reactor was cooled at ca. 40° C./min. Yield: 0.122 g (expected for pure Fe: 0.112 g; expected for pure Fe₄N: 0.119 g). The pXRD pattern in FIG. 3 (bottom) shows the crystalline product is pure γ′-FeAN. EDS (Table 2) provides a composition of 93-98 at. % Fe, O at. % O, and 0-6 at. % N. Although the EDS data may suggest a mixture of iron and iron nitride (by comparison with Method C1, below), the pXRD data clearly show no crystalline α-Fe.

Elemental microanalysis by combustion indicates 5.9±0.4 wt. % N. Expected for Fe₄N: 5.9 wt. % N.

TABLE 2

| Reactor | Iron at. % | Oxygen at. % | Nitrogen at. % |
|---|---|---|---|
| Position | (Fe Kα) | (O Kα) | (N Kα) |
| Front 1 | 97 ± 1 | 0 ± 1 | 2 ± 1 |
| Front 2 | 93 ± 1 | 0 ± 1 | 6 ± 1 |
| Back 1 | 95 ± 1 | 0 ± 1 | 4 ± 1 |
| Back 2 | 96 ± 1 | 0 ± 1 | 4 ± 1 |
| Bottom 1 | 98 ± 1 | 0 ± 1 | 2 ± 1 |
| Bottom 2 | 97 ± 1 | 0 ± 1 | 3 ± 1 |

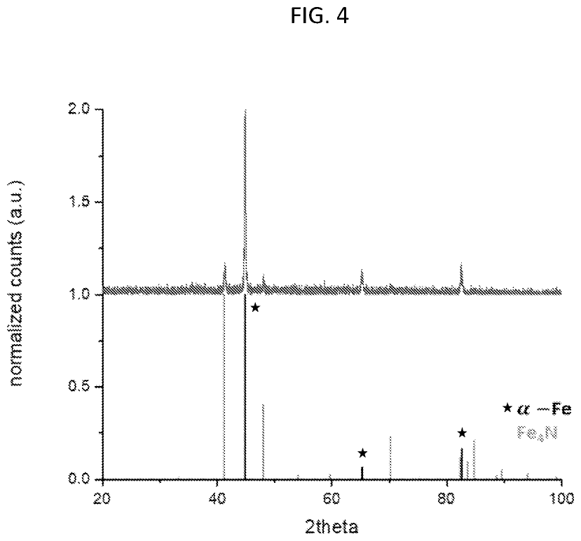

Method C, producing a mixture of iron and iron nitride. Variant 1. The quartz boat was charged with 0.160 g (1.00 mmol) of iron(III) oxide and loaded into the reactor. The reactor was purged with argon at 120 sccm for 5 minutes. The reactor is then heated under 120 sccm Ar at 20° C./min to 700° C., at which temperature the Ar flow was stopped and a flow of 120 sccm of NH₃ was introduced. After flowing at this rate for 5 minutes, the ammonia flow was stopped and the Ar flow was resumed at 120 sccm. The reactor was cooled at ca. 40° C./min. Yield: 0.116 g (expected for pure Fe: 0.113 g). The pXRD pattern shown in FIG. 4 reveals a mixture of iron and iron nitride, with the majority of the material being iron. EDS (Table 3) provides a composition 93-100 at. % Fe, 0-1 at. % O, and 0-6 at. % N, depending on location. The EDS system detects iron more effectively than nitrogen, so the exact quantification of the N content is not reliable by this method; however, the results are consistent with the pXRD pattern in suggesting the product is primarily iron with a small amount of iron nitride mixed in.

TABLE 3

| Reactor | Iron at. % | Oxygen at. % | Nitrogen at. % |
|---|---|---|---|
| Position | (Fe Kα) | (O Kα) | (N Kα) |
| Front 1 | 100 ± 1 | 0 ± 1 | 0 ± 1 |
| Front 2 | 98 ± 1 | 1 ± 1 | 1 ± 1 |
| Back 1 | 93 ± 1 | 1 ± 1 | 6 ± 1 |
| Back 2 | 94 ± 1 | 0 ± 1 | 6 ± 1 |
| Bottom 1 | 95 ± 1 | 1 ± 1 | 4 ± 1 |
| Bottom 2 | 100 ± 1 | 0 ± 1 | 0 ± 1 |

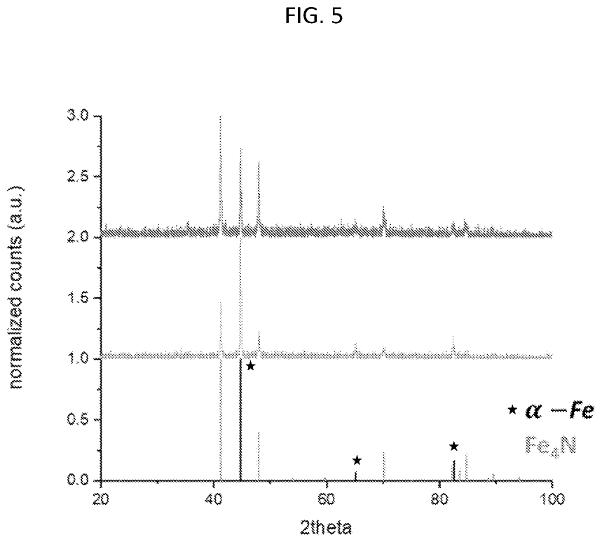

Method C, variant 2. A mixture of iron and iron nitride can also be produced by holding under 40 sccm NH₃ for 10 minutes at 700° C. The quartz boat was charged with 0.179 g (1.11 mmol) of iron(III) oxide and loaded into the reactor. The reactor was purged with argon at 40 sccm for 10 minutes. The reactor was then heated under 40 sccm Ar at 20° C./min to 700° C., at which temperature the Ar flow was stopped and a flow of 40 sccm of NH₃ was introduced. After flowing at this rate for 10 minutes, the ammonia flow was stopped and the Ar flow was resumed at 40 sccm. The reactor was cooled at ca. 40° C./min. Yield: 0.134 g (expected for pure Fe: 0.125 g). FIG. 5 (top) shows a mixture of iron and iron nitride by pXRD. Composition by EDS (Table 4): 90-98 at. % Fe, 0-1 at. % O, and 1-9 at. % N.

TABLE 4

| Reactor | Iron at. % | Oxygen at. % | Nitrogen at. % |
|---|---|---|---|
| Position | (Fe Kα) | (O Kα) | (N Kα) |
| Front 1 | 98 ± 1 | 0 ± 1 | 1 ± 1 |
| Front 2 | 90 ± 1 | 1 ± 1 | 9 ± 1 |
| Back 1 | 95 ± 1 | 1 ± 1 | 4 ± 1 |
| Back 2 | 93 ± 1 | 1 ± 1 | 5 ± 1 |
| Bottom 1 | 96 ± 1 | 1 ± 1 | 4 ± 1 |
| Bottom 2 | 91 ± 1 | 0 ± 1 | 9 ± 1 |

Method C, variant 3. Holding the charge at 700° C. under Ar flow for an additional 5 minutes after the NH₃ flow is stopped, before cooling the reactor, results in less iron nitride in the mixture. The quartz boat was charged with 0.165 g (1.03 mmol) of iron(III) oxide and loaded into the reactor. The reactor was purged with argon at 40 sccm for 10 minutes. The reactor was then heated under 40 sccm of Ar at 20° C./min to 700° C., at which temperature the Ar flow was stopped and a flow of 40 sccm of NH₃ was introduced. After flowing at this rate for 10 minutes, the ammonia flow was stopped and the Ar flow was resumed at 40 sccm. The reactor was held at 700° C. for an additional 5 minutes, and then the reactor was cooled at ca. 40° C./min. Yield: 0.121 g (expected for pure Fe: 0.115 g). The pXRD pattern in FIG. 5 (bottom) shows the product is a mix of α-Fe and Fe₄N, enriched in iron relative to Method C2 (top). EDS composition (Table 5): 95-100 at. % Fe, 0-2 at. % O, and 1-2 at. % N.

TABLE 5

| Reactor | Iron at. % | Oxygen at. % | Nitrogen at. % |
|---|---|---|---|
| Position | (Fe Kα) | (O Kα) | (N Kα) |
| Front 1 | 100 ± 1 | 0 ± 1 | 0 ± 1 |
| Front 2 | 97 ± 1 | 1 ± 1 | 1 ± 1 |
| Back 1 | 95 ± 1 | 2 ± 1 | 2 ± 1 |
| Back 2 | 98 ± 1 | 1 ± 1 | 1 ± 1 |
| Bottom 1 | 98 ± 1 | 1 ± 1 | 1 ± 1 |
| Bottom 2 | 97 ± 1 | 1 ± 1 | 2 ± 1 |

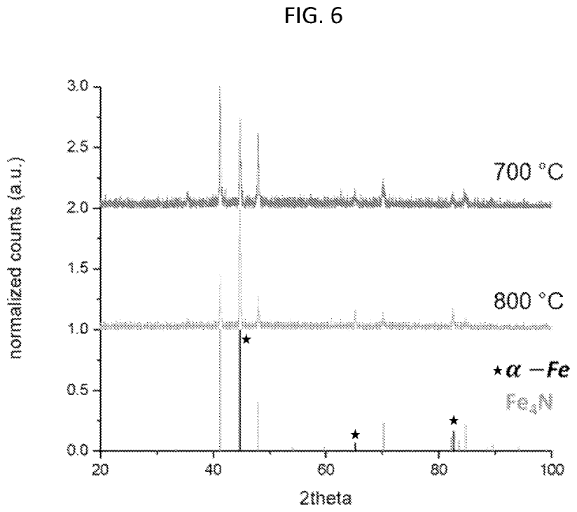

Method C, variant 4. The quartz boat was charged with 0.179 g (1.12 mmol) of iron(III) oxide and loaded into the reactor. The reactor was purged with argon at 40 sccm for 10 minutes. The reactor was then heated under 40 sccm Ar at 20° C./min to 700° C., at which temperature the Ar flow was stopped and a flow of 40 sccm of NH₃ was introduced. After flowing at this rate for 10 minutes, the ammonia flow was stopped and the Ar flow was resumed at 40 sccm. The reactor was cooled at ca. 40° C./min. Yield: 0.134 g (expected for pure Fe: 0.125 g). EDS composition: 90-98 at. % Fe, 0-1 at. % O, and 1-9 at. % N. FIG. 6 (top) displays the pXRD pattern for this sample, which is a mixture of iron and Fe₄N.

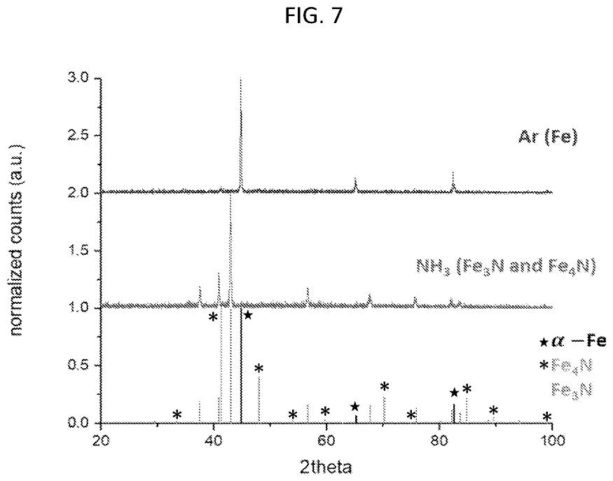

Method D, producing iron nitride with higher nitrogen content (mostly ε-Fe₃N). The quartz boat was charged with 0.162 g (1.01 mmol) of iron(III) oxide and loaded into the reactor. The reactor was purged with argon at 120 sccm for 5 minutes. The reactor was then heated under 120 sccm Ar at 20° C./min to 700° C., at which temperature the Ar flow was stopped and a flow of 120 sccm of NH₃ was introduced. After flowing at this rate for 10 minutes, the furnace set point was set to room temperature, and the sample was cooled under a 120 sccm flow of ammonia. The reactor was cooled at ca. 40° C./min. Yield: 0.129 g (expected for pure Fe: 0.112 g; expected for pure Fe₃N: 0.121 g). The pXRD pattern in FIG. 7 (bottom) shows the product is predominantly ε-Fe₃N, perhaps with some γ′-Fe₄N. EDS (Table 6) provides a composition of 89-99 at. % Fe, 0 at. % O, and 1-11 at. % N. Both the EDS and pXRD data show higher nitrogen content than for the samples prepared by Method C.

TABLE 6

| Reactor | Iron at. % | Oxygen at. % | Nitrogen at. % |
|---|---|---|---|
| Position | (Fe Kα) | (O Kα) | (N Kα) |
| Front 1 | 92 ± 1 | 0 ± 1 | 8 ± 1 |
| Front 2 | 91 ± 1 | 0 ± 1 | 9 ± 1 |
| Back 1 | 93 ± 1 | 0 ± 1 | 7 ± 1 |
| Back 2 | 99 ± 1 | 0 ± 1 | 1 ± 1 |
| Bottom 1 | 89 ± 1 | 0 ± 1 | 11 ± 1 |
| Bottom 2 | 89 ± 1 | 0 ± 1 | 11 ± 1 |

### Example 2. Reduction of Iron(III) Oxide at 800° C.

In general, similar methods work at 800° C. as at 700° C., but with less incorporation of nitrogen under the same conditions.

Method C, variant 4, 800° C. version. By increasing the reaction hold temperature to 800° C., the iron nitride content can be decreased in the mixture of iron and iron nitride. In this experiment, the quartz boat was charged with 0.166 g (1.04 mmol) of iron(III) oxide and loaded into the reactor. The reactor was purged with argon at 40 sccm for 10 minutes. The reactor was then heated under 40 sccm Ar at 20° C./min to 800° C., at which temperature the Ar flow was stopped and a flow of 40 sccm of NH₃ was introduced. After flowing at this rate for 10 minutes, the ammonia flow was stopped and the Ar flow was resumed at 40 sccm. The reactor was cooled at ca. 40° C./min. Yield: 0.119 g (expected for pure Fe: 0.116 g). The pXRD patterns in FIG. 6 show the product is a mix of γ′-Fe₄N and α-Fe at 700° C. (top), and at 800° C. (bottom). Less Fe₄N is present at 800° C. EDS composition: 97-100 at. % Fe, 0-2 at. % O, and 0-2 at. % N for the reduction at 800° C. (cf. 90-98 at. % Fe, 0-1 at. % O, and 1-9 at. % N for the reduction at 700° C., Method C4).

### Example 3. Reduction of Iron(III) Oxide at 1000° C.

By increasing the reaction temperature we are able to increase the rate of reduction as well as the fraction of ammonia delivered that is used in the reduction.

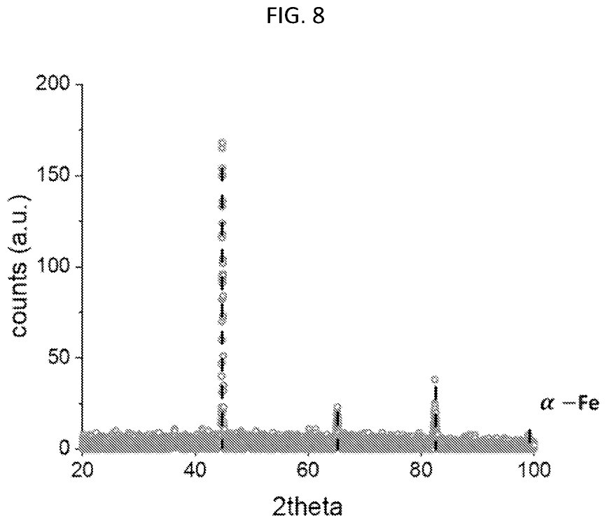

Method E, producing pure iron at 1000° C. The quartz boat was charged with 0.160 g (1.00 mmol) of iron(III) oxide and loaded into the reactor. The reactor was purged with argon at 80 sccm for 5 minutes. The reactor was then heated under 80 sccm Ar at 20° C./min to 1000° C., at which temperature the Ar flow was stopped and a flow of 80 sccm of NH₃ was introduced. After flowing at this rate for 1 minute, the ammonia flow was stopped and the Ar flow was resumed at 80 sccm. The reactor was cooled at ca. 40° C./min. Yield: 0.116 g (expected for pure Fe: 0.112 g). The pXRD pattern in FIG. 8 shows the product is pure α-Fe. EDS (Table 7) provides a composition of 96-100 at. % Fe, 0-1 at. % O, and 0-3 at. % N.

In this reaction, 80 mL NH₃ (3.57 mmol) were delivered; 2.00 mmol were needed for complete reduction of Fe₂O₃ to 2 Fe, implying 56% of the NH₃ delivered was used to produce iron.

Elemental microanalysis by combustion indicates ≤0.7±0.4 wt. % N. Expected for pure Fe: 0.0 wt. % N.

TABLE 7

| Reactor | Iron at. % | Oxygen at. % | Nitrogen at. % |
|---|---|---|---|
| Position | (Fe Kα) | (O Kα) | (N Kα) |
| Front 1 | 98 ± 1 | 1 ± 1 | 1 ± 1 |
| Front 2 | 96 ± 1 | 1 ± 1 | 3 ± 1 |
| Back 1 | 100 ± 1 | 0 ± 1 | 0 ± 1 |
| Back 2 | 100 ± 1 | 0 ± 1 | 0 ± 1 |
| Bottom 1 | 99 ± 1 | 1 ± 1 | 0 ± 1 |
| Bottom 2 | 99 ± 1 | 1 ± 1 | 0 ± 1 |

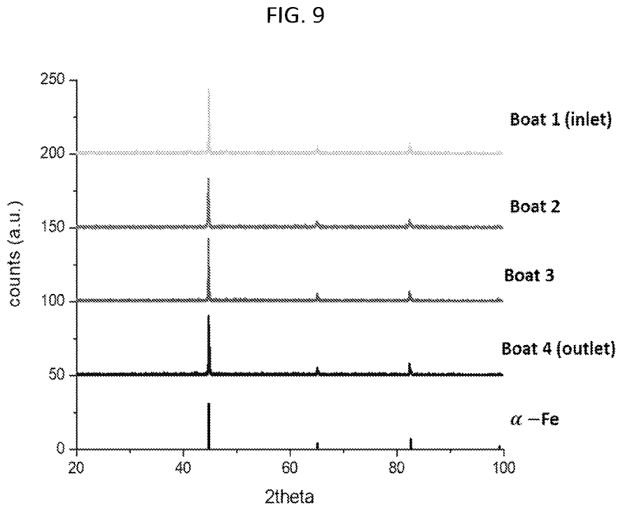

Method F, scale up of method E by 5×. The full sample charge of 0.811 g (5.08 mmol) of iron(III) oxide was divided among 4 quartz boats in the reactor, with approximately 0.200 g in each boat. The boats were placed in the reactor with equal spacing between them. Boat 1 was placed closest to the inlet of the reactor, and boat 4 closest to the outlet. After the samples were loaded, the reactor was purged with 80 sccm of Ar for 5 minutes. The reactor was then heated under 80 sccm Ar at 20° C./min to 1000° C., at which temperature the Ar flow was stopped and a flow of 400 sccm of NH₃ was introduced. After flowing at this rate for 1 minute, the ammonia flow was stopped and the Ar flow was resumed at 80 sccm. The reactor was cooled at ca. 40° C./min. Yield: 0.572 g (expected for pure Fe: 0.568 g). The pXRD patterns in FIG. 9 show the product is pure α-Fe across the four different quartz boats. The composition measured by EDS (Table 8) is 98-100 at. % Fe, 0-2 at. % O, 0-1 at. % N.

In this reaction, 400 mL NH₃ (17.9 mmol) were delivered; 10.2 mmol were needed for complete reduction of Fe₂O₃ to 2 Fe, thus 57% of the NH₃ delivered was used to produce iron.

TABLE 8

| Reactor | Iron at. % | Oxygen at. % | Nitrogen at. % |
|---|---|---|---|
| Position | (Fe Kα) | (O Kα) | (N Kα) |
| Boat 1, front 1 | 100 ± 1 | 0 ± 1 | 0 ± 1 |
| Boat 1, front 2 | 99 ± 1 | 0 ± 1 | 1 ± 1 |
| Boat 1, back 1 | 100 ± 1 | 0 ± 1 | 0 ± 1 |
| Boat 1, back 2 | 100 ± 1 | 0 ± 1 | 0 ± 1 |
| Boat 2, front 1 | 99 ± 1 | 0 ± 1 | 1 ± 1 |
| Boat 2, front 2 | 99 ± 1 | 0 ± 1 | 1 ± 1 |
| Boat 2, back 1 | 99 ± 1 | 0 ± 1 | 1 ± 1 |
| Boat 2, back 2 | 100 ± 1 | 0 ± 1 | 0 ± 1 |
| Boat 3, front 1 | 99 ± 1 | 0 ± 1 | 1 ± 1 |
| Boat 3, front 2 | 100 ± 1 | 0 ± 1 | 0 ± 1 |
| Boat 3, back 1 | 100 ± 1 | 0 ± 1 | 0 ± 1 |
| Boat 3, back 2 | 100 ± 1 | 0 ± 1 | 0 ± 1 |
| Boat 4, front 1 | 98 ± 1 | 2 ± 1 | 0 ± 1 |
| Boat 4, front 2 | 98 ± 1 | 2 ± 1 | 0 ± 1 |
| Boat 4, back 1 | 98 ± 1 | 2 ± 1 | 0 ± 1 |
| Boat 4, back 2 | 100 ± 1 | 0 ± 1 | 0 ± 1 |

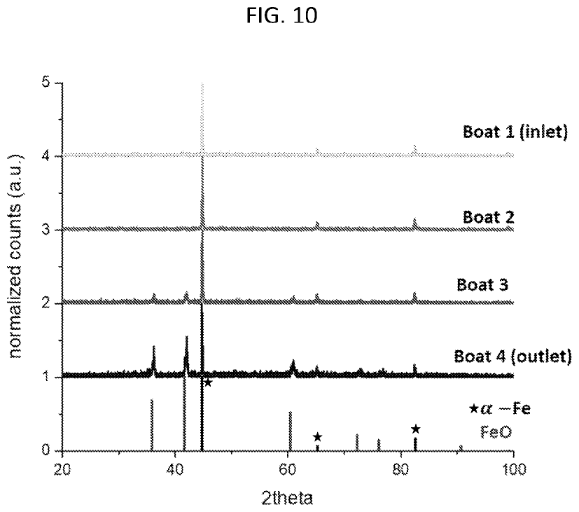

Method G, scale up of method E by 10×. A further scale up was attempted, with a full sample charge of 1.606 grams (10.1 mmol) of iron(III) oxide. The charge was distributed across 4 quartz boats, with approximately 0.400 g in each boat. After loading the samples and purging with Ar (80 sccm, 5 min), the reactor was heated under 80 sccm Ar at 20° C./min to 1000° C. At this temperature the Ar flow was stopped and a flow of 800 sccm of NH₃ was introduced. After flowing at this rate for 1 minute, the ammonia flow was stopped and the Ar flow was resumed at 80 sccm. The reactor was cooled at ca. 40° C./min. Yield: 1.123 g (expected for pure Fe: 1.194 g). The pXRD data in FIG. 10 show the product is pure α-Fe in boats 1 and 2, but Fe and FeO in boats 3 and 4. EDS composition (Table 9) is 98-99 at. % Fe, 0-2 at. % O, 0-1 at. % N for boats 1-3, but 80-98 at. % Fe, 2-20 at. % O, 0-5 at. % N for boat 4.

TABLE 9

| Reactor | Iron at. % | Oxygen at. % | Nitrogen at. % |
|---|---|---|---|
| Position | (Fe Kα) | (O Kα) | (N Kα) |
| Boat 1, front 1 | 99 ± 1 | 1 ± 1 | 0 ± 1 |
| Boat 1, front 2 | 99 ± 1 | 1 ± 1 | 0 ± 1 |
| Boat 1, back 1 | 99 ± 1 | 1 ± 1 | 0 ± 1 |
| Boat 1, back 2 | 99 ± 1 | 1 ± 1 | 0 ± 1 |
| Boat 2, front 1 | 99 ± 1 | 1 ± 1 | 0 ± 1 |
| Boat 2, front 2 | 99 ± 1 | 1 ± 1 | 0 ± 1 |
| Boat 2, back 1 | 99 ± 1 | 0 ± 1 | 0 ± 1 |
| Boat 2, back 2 | 98 ± 1 | 0 ± 1 | 1 ± 1 |
| Boat 3, front 1 | 99 ± 1 | 1 ± 1 | 0 ± 1 |
| Boat 3, front 2 | 98 ± 1 | 2 ± 1 | 0 ± 1 |
| Boat 3, back 1 | 99 ± 1 | 1 ± 1 | 0 ± 1 |
| Boat 3, back 2 | 99 ± 1 | 1 ± 1 | 0 ± 1 |
| Boat 4, front 1 | 80 ± 1 | 20 ± 1 | 0 ± 1 |
| Boat 4, front 2 | 82 ± 1 | 17 ± 1 | 1 ± 1 |
| Boat 4, back 1 | 81 ± 1 | 14 ± 1 | 5 ± 1 |
| Boat 4, back 2 | 98 ± 1 | 2 ± 1 | 0 ± 1 |

### Example 4. Reduction of iron(III) oxide at 900° C.

Method E, variant 2, producing pure iron at 900° C. The quartz boat was charged with 0.163 g (1.02 mmol) of iron(III) oxide and loaded into the reactor. The reactor was purged with argon at 80 sccm for 10 minutes. The reactor was then heated under 80 sccm Ar at 20° C./min to 1000° C., at which temperature the Ar flow was stopped and a flow of 80 sccm of NH₃ was introduced. After flowing at this rate for 1 minute, the ammonia flow was stopped and the Ar flow was resumed at 80 sccm. The reactor was cooled at ca. 40° C./min. Yield: 0.114 g (expected for pure Fe: 0.114)

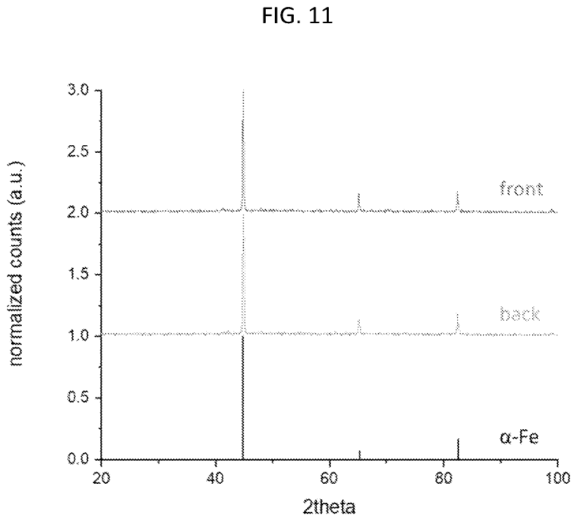

The pXRD pattern shows the crystalline product is pure α-Fe (FIG. 11). EDS (Table 10) provides a composition of 99-100 at. % Fe, 0-1 at. % O and 0-1 at. % N.

TABLE 10

| Reactor | Iron at. % | Oxygen at. % | Nitrogen at. % |
|---|---|---|---|
| Position | (Fe Kα) | (O Kα) | (N Kα) |
| Front 1 | 98.9 ± 1 | 0.0 ± 1 | 1.1 ± 1 |
| Front 2 | 100.0 ± 1 | 0.0 ± 1 | 0.0 ± 1 |
| Back 1 | 99.4 ± 1 | 0.6 ± 1 | 0.0 ± 1 |
| Back 2 | 99.9 ± 1 | 0.0 ± 1 | 0.2 ± 1 |
| Bottom 1 | 99.7 ± 1 | 0.0 ± 1 | 0.3 ± 1 |
| Bottom 2 | 100.0 ± 1 | 0.0 ± 1 | 0.0 ± 1 |
| Middle 1 | 99.5 ± 1 | 0.0 ± 1 | 0.6 ± 1 |
| Middle 2 | 99.0 ± 1 | 0.2 ± 1 | 0.8 ± 1 |

### Example 5. Reduction of Sintered Iron(III) Oxide

Chunks of sintered iron(III) oxide (Alfa Aesar, 3-12 mm, 99.85+% purity) were used as starting material to more closely replicate the size, porosity, and surface area of ore used in industrial ironmaking processes. Compared with the iron(III) oxide powder we used in previous experiments, the sintered iron(III) oxide has a larger particle size, a lower porosity, and a smaller surface area. Similar conditions reduce the iron(III) oxide chunks, although they typically require a longer hold time at the reaction temperature. Larger residual oxygen content is observed for the chunks than for the powder we most commonly used.

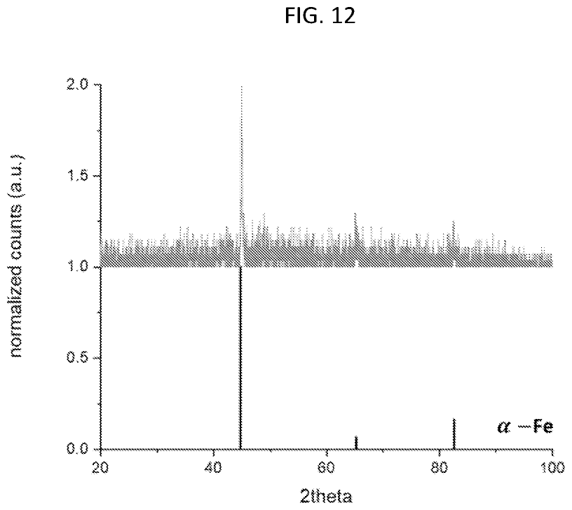

Method H, producing pure iron from a chunk of sintered iron(III) oxide at 1000° C. The quartz boat was charged with a chunk of sintered iron(III) oxide ca. 10 mm in length×5 mm in width with a mass of 0.159 g (1.00 mmol). The reactor was purged with argon at 120 sccm for 5 minutes. The reactor was then heated under 80 sccm Ar at 20° C./min to 1000° C., at which temperature the Ar flow was stopped and a flow of 80 sccm of NH₃ was introduced. After flowing at this rate for 5 minutes, the ammonia flow was stopped and the Ar flow was resumed at 80 sccm. The reactor was cooled at ca. 40° C./min. Yield: 0.130 g (expected for pure Fe: 0.111 g). The pXRD pattern in FIG. 12 shows the crystalline product is pure α-Fe. EDS composition (Table 11): 88-100 at. % Fe, 0-1 at. % N, and 0-12 at. % O.

TABLE 11

| Reactor | Iron at. % | Oxygen at. % | Nitrogen at. % |
|---|---|---|---|
| Position | (Fe Kα) | (O Kα) | (N Kα) |
| Top 1 | 100 ± 1 | 0 ± 1 | 0 ± 1 |
| Top 2 | 99 ± 1 | 0 ± 1 | 0 ± 1 |
| Top 3 | 88 ± 1 | 12 ± 1 | 0 ± 1 |
| Bottom 1 | 96 ± 1 | 4 ± 1 | 0 ± 1 |
| Bottom 2 | 90 ± 1 | 9 ± 1 | 1 ± 1 |
| Bottom 3 | 95 ± 1 | 5 ± 1 | 0 ± 1 |

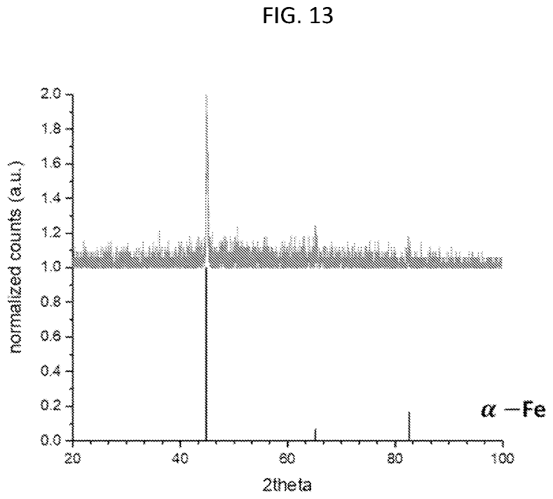

Method I, producing iron from a chunk of sintered iron(III) oxide at 900° C. The quartz boat was charged with a chunk of sintered iron(III) oxide ca. 10 mm in length×5 mm in width with a mass of 0.167 g (1.05 mmol). The reactor was purged with argon at 120 sccm for 5 minutes. The reactor was then heated under 120 sccm Ar at 20° C./min to 900° C., at which temperature the Ar flow was stopped and a flow of 120 sccm of NH₃ was introduced. After flowing at this rate for minutes, the ammonia flow was stopped and the Ar flow was resumed at 120 sccm. The reactor was cooled at ca. 40° C./min. Yield: 0.117 g (expected for pure Fe: 0.116 g). The pXRD pattern in FIG. 13 shows the product is pure α-Fe. EDS composition (Table 12): 87-98 at. % Fe, 0-2 at. % 10 N, and 1-13 at. % O.

TABLE 12

| Reactor | Iron at. % | Oxygen at. % | Nitrogen at. % |
|---|---|---|---|
| Position | (Fe Kα) | (O Kα) | (N Kα) |
| Top 1 | 92 ± 1 | 6 ± 1 | 2 ± 1 |
| Top 2 | 87 ± 1 | 13 ± 1 | 0 ± 1 |
| Top 3 | 92 ± 1 | 8 ± 1 | 1 ± 1 |
| Bottom 1 | 96 ± 1 | 4 ± 1 | 0 ± 1 |
| Bottom 2 | 98 ± 1 | 2 ± 1 | 0 ± 1 |
| Bottom 3 | 99 ± 1 | 1 ± 1 | 0 ± 1 |

### Example 6. Reduction of Taconite Ore Material

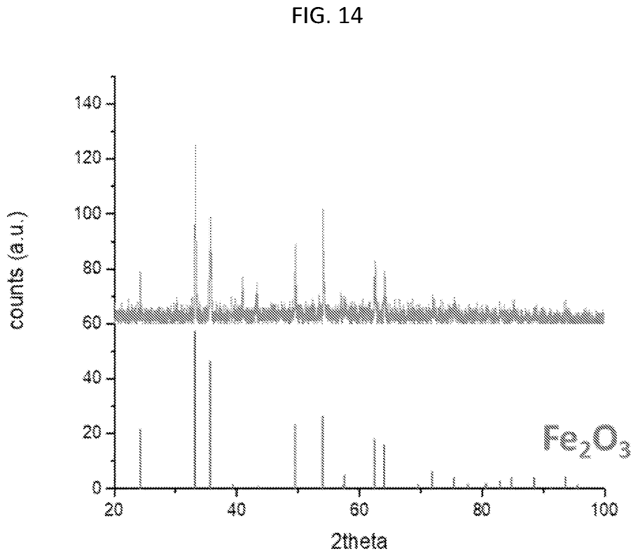

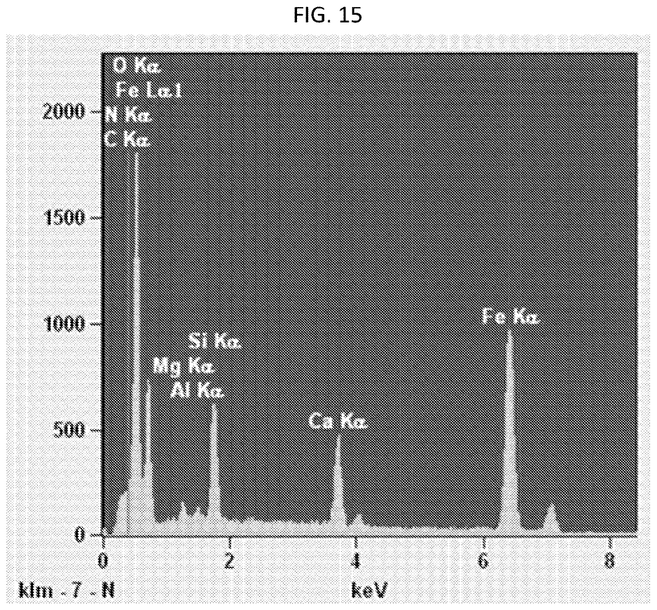

Sample iron ore pellets derived from Minnesota taconite were purchased via eBay; similar pellets are used in industrial ironmaking. The ore was analyzed by pXRD (FIG. 14) and EDS (FIG. 15) prior to reduction and observed to be iron(III) oxide, mixed with oxides of silicon, aluminum, magnesium, and calcium. These elements are present in the original taconite ore, in the clay used as a binder during sintering to form the iron(III) oxide pellet, or in both. Thermodynamically, these other oxides cannot be reduced by ammonia at the temperatures we use for iron oxide reduction.

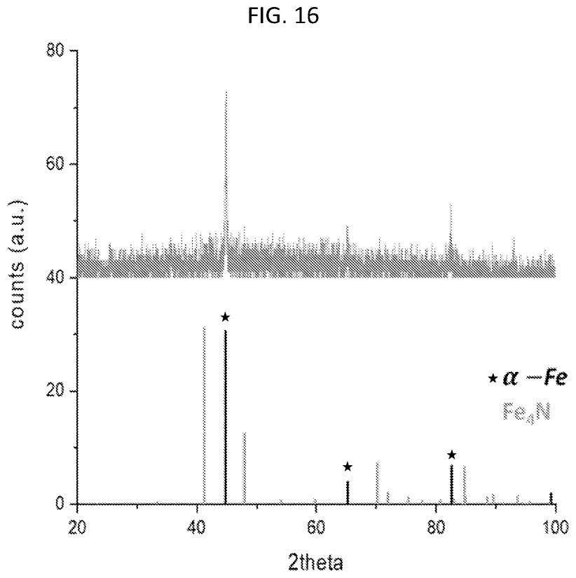

Method J, producing iron from a chunk of taconite ore. The pelletized ore received from Minnesota varies in size and a typical pellet is 1-2 cm in diameter. To maintain the smaller (1 mmol) scale used in the powder runs for direct comparison across iron oxide starting material, the pellet was crushed (but not ground) and a chunk was used for reduction. The quartz boat was charged with a chunk with a mass of 0.162 g (1.01 mmol) and loaded into the reactor. The reactor was purged with argon at 120 sccm for 5 minutes. The reactor was then heated under 120 sccm Ar at 20° C./min to 700° C., at which temperature the Ar flow was stopped and a flow of 120 sccm of NH₃ was introduced. After flowing at this rate for 10 minutes, the ammonia flow was stopped and the Ar flow was resumed at 120 sccm. The reactor was cooled at ca. 40° C./min. Yield: 0.130 g (expected for pure Fe: 0.113 g). The pXRD pattern in FIG. 16 shows the only crystalline product is α-Fe. The EDS composition (Tables 13, 14) is: 67-89 at. % Fe, 0-7 at. % N, 3-14 at. % O, and 8-19 at. % Al/Ca/Mg/Si. The oxygen present by EDS is likely associated with the other metals (which cannot be reduced by ammonia under these conditions). In a steelmaking process, these impurities would be removed as part of the slag when the reduced iron pellet is melted.

TABLE 13

| Reactor | Iron at. % | Gangue at. % | Oxygen at. % | Nitrogen at. % |
|---|---|---|---|---|
| Position | (Fe Kα) | (Table 14) | (O Kα) | (N Kα) |
| Mix 1 | 73 ± 1 | 16 ± 1 | 11 ± 1 | 0 ± 1 |
| Mix 2 | 79 ± 1 | 13 ± 1 | 8 ± 1 | 0 ± 1 |
| Mix 3 | 69 ± 1 | 13 ± 1 | 11 ± 1 | 7 ± 1 |
| Bottom 1 | 89 ± 1 | 8 ± 1 | 3 ± 1 | 0 ± 1 |
| Bottom 2 | 67 ± 1 | 19 ± 1 | 14 ± 1 | 0 ± 1 |
| Bottom 3 | 73 ± 1 | 16 ± 1 | 11 ± 1 | 0 ± 1 |

TABLE 14

| | Aluminum | | Magnesium | |
|---|---|---|---|---|
| Reactor | at. % | Calcium at. % | at. % | Silicon at. % |
| Position | (Al Kα) | (Ca Kα) | (Mg Kα) | (Si Kα) |
| Mix 1 | 1 ± 1 | 7 ± 1 | 1 ± 1 | 6 ± 1 |
| Mix 2 | 1 ± 1 | 7 ± 1 | 1 ± 1 | 4 ± 1 |
| Mix 3 | 1 ± 1 | 5 ± 1 | 2 ± 1 | 6 ± 1 |
| Bottom 1 | 0 ± 1 | 5 ± 1 | 1 ± 1 | 2 ± 1 |
| Bottom 2 | 0 ± 1 | 9 ± 1 | 1 ± 1 | 8 ± 1 |
| Bottom 3 | 1 ± 1 | 8 ± 1 | 1 ± 1 | 6 ± 1 |

Method K, producing iron and iron nitride from BF-grade ore powder. A pellet of fired taconite was crushed to a powder in a mortar with a pestle. The quartz boat was charged with 0.169 g (1.00 mmol assuming 5 wt. % gangue) of crushed BF-grade ore powder and loaded into the reactor. The reactor was purged with argon at 120 sccm for 5 minutes. The reactor was then heated under 120 sccm Ar at 20° C./min to 600° C., at which temperature the Ar flow was stopped and a flow of 120 sccm of NH₃ was introduced. After flowing at this rate for 10 minutes, the ammonia flow was stopped and the Ar flow was resumed at 120 sccm. The reactor was cooled at ca. 40° C./min. Yield: 0.126 g (expected for pure Fe with 5 wt. % gangue: 0.120 g)

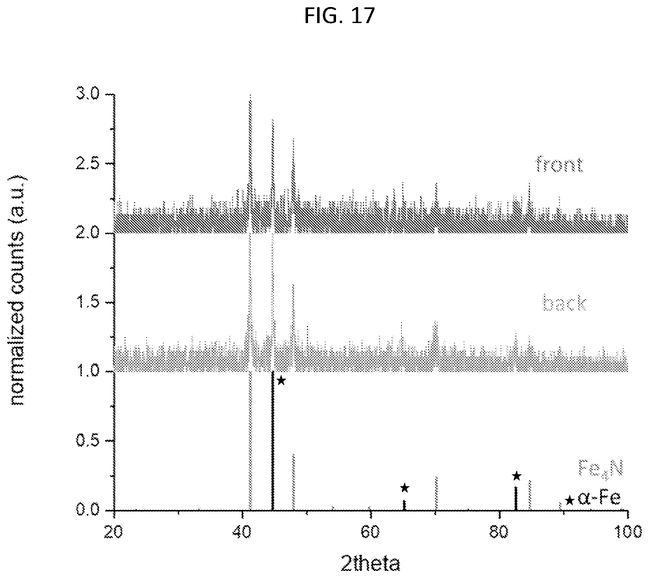

The pXRD pattern shows the crystalline product is a mix of Fe and Fe₄N (FIG. 17). EDS (Table 15) provides a composition of 87-95 at. % Fe, 4-11 at. % O (presumably from gangue oxides), and 0-6 at. % N.

TABLE 15

| Reactor | Iron at. % | Oxygen at. % | Nitrogen at. % |
|---|---|---|---|
| Position | (Fe Kα) | (O Kα) | (N Kα) |
| Front 1 | 90.9 ± 1 | 9.1 ± 1 | 0.0 ± 1 |
| Front 2 | 89.4 ± 1 | 7.7 ± 1 | 2.9 ± 1 |
| Back 1 | 91.7 ± 1 | 8.3 ± 1 | 0.0 ± 1 |
| Back 2 | 95.1 ± 1 | 4.1 ± 1 | 0.8 ± 1 |
| Bottom 1 | 88.5 ± 1 | 8.9 ± 1 | 2.6 ± 1 |
| Bottom 2 | 88.7 ± 1 | 11.3 ± 1 | 0.0 ± 1 |
| Middle 1 | 90.1 ± 1 | 9.9 ± 1 | 0.0 ± 1 |
| Middle 2 | 86.7 ± 1 | 7.7 ± 1 | 5.6 ± 1 |

Method L, producing iron and iron nitride from BF-grade ore powder. A pellet of fired taconite was crushed to a powder in a mortar with a pestle. The quartz boat was charged with 0.165 g (0.98 mmol assuming 5 wt. % gangue) of crushed BF-grade ore powder and loaded into the reactor. The reactor was purged with argon at 40 sccm for 10 minutes. The reactor was then heated under 40 sccm Ar at 20° C./min to 600° C., at which temperature the Ar flow was stopped and a flow of 120 sccm of NH₃ was introduced. After flowing at this rate for 10 minutes, the ammonia flow was stopped and the Ar flow was resumed at 40 sccm. The reactor was cooled at ca. 40° C./min. Yield: 0.134 g (expected for pure Fe with 5 wt. % gangue: 0.110 g; expected for pure Fe₄N with 5 wt. % gangue: 0.117 g)

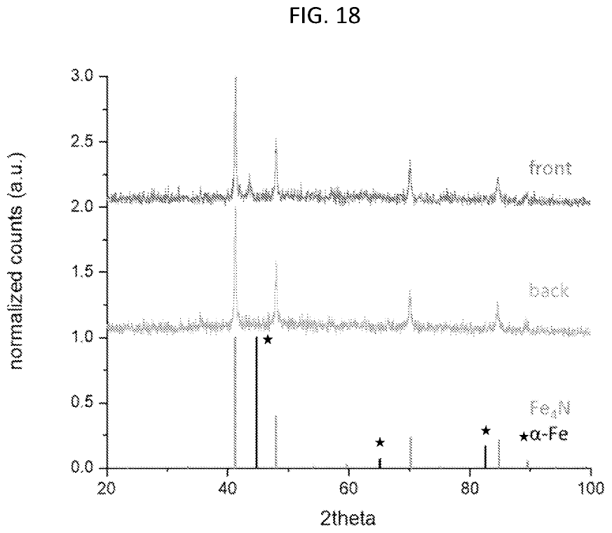

The pXRD pattern shows the crystalline product is FeAN with a small amount of Fe₃N (FIG. 18). EDS (Table 16) provides a composition of 78-95 at. % Fe, 6-14 at. % O (presumably from gangue oxides), and 0-8 at. % N.

TABLE 16

| Reactor | Iron at. % | Oxygen at. % | Nitrogen at. % |
|---|---|---|---|
| Position | (Fe Kα) | (O Kα) | (N Kα) |
| Front 1 | 78.3 ± 1 | 14.0 ± 1 | 7.7 ± 1 |
| Front 2 | 90.0 ± 1 | 8.2 ± 1 | 1.8 ± 1 |
| Back 1 | 91.8 ± 1 | 6.6 ± 1 | 1.6 ± 1 |
| Back 2 | 86.9 ± 1 | 11.0 ± 1 | 2.2 ± 1 |
| Bottom 1 | 95.2 ± 1 | 4.8 ± 1 | 0.0 ± 1 |
| Bottom 2 | 95.3 ± 1 | 4.7 ± 1 | 0.0 ± 1 |
| Middle 1 | 93.7 ± 1 | 6.3 ± 1 | 0.0 ± 1 |
| Middle 2 | 87.4 ± 1 | 9.9 ± 1 | 2.7 ± 1 |

Method M, producing iron from a BF-grade ore pellet. The quartz boat was charged with a whole, fired taconite ore pellet, 1.197 g (7.12 mmol Fe₂O₃ assuming 5 wt. % gangue), and loaded into the reactor. The reactor was purged with argon at 200 sccm for 5 minutes. The reactor was then heated under 200 sccm Ar at 20° C./min to 1000° C. At this temperature, the Ar flow was stopped and a flow of 500 sccm NH₃ was introduced for 1 minute. The NH₃ flow was stopped and 200 sccm Ar was introduced for 2 minutes. This pulse sequence was repeated 8 more times, for a total ammonia delivery of 4.5 L, distributed among the 9 pulses. The reactor was cooled under 200 sccm Ar at ca. 40° C./min. Yield: 0.923 g (expected for pure Fe with 5 wt. % gangue: 0.855 g).

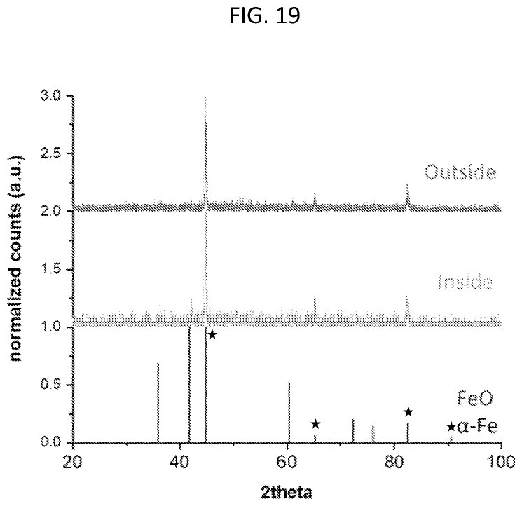

The pXRD pattern shows the crystalline product is Fe (FIG. 19).

### Example 7. Reduction of Magnetite Ore Concentrate

Samples of blast-furnace grade magnetite concentrate (beneficiated taconite) were supplied by the Natural Resources Research Institute (NRRI) of the University of Minnesota. Magnetite ore concentrates samples were reduced with ammonia.

Method N, producing iron nitride, γ′-Fe₄N at 700° C. The quartz boat was charged with 0.235 g (0.96 mmol Fe₃O₄ assuming 5 wt. % gangue) magnetite ore concentrate and loaded into the reactor. The reactor was purged with argon at 40 sccm for 10 minutes. The reactor was then heated under 40 sccm Ar at 20° C./min to 700° C., at which temperature the Ar flow was stopped and a flow of 160 sccm of NH₃ was introduced. After flowing at this rate for 10 minutes, the ammonia flow was stopped and the Ar flow was resumed at 40 sccm. The reactor was cooled at ca. 40° C./min. Yield: 0.180 g (expected for pure Fe₄N with 5 wt. % gangue: 0.183 g).

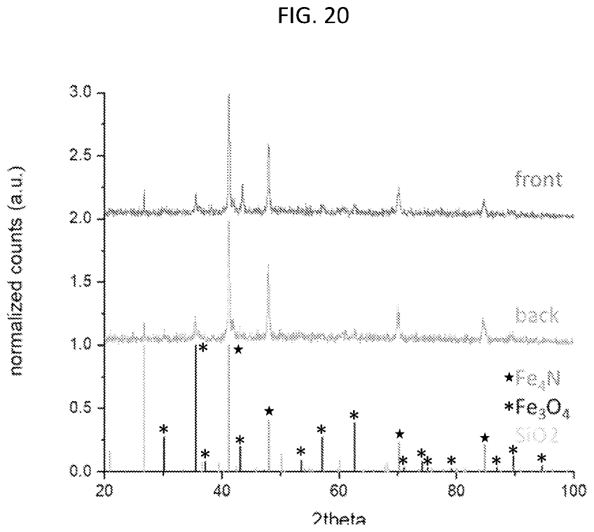

The pXRD pattern shows the crystalline product is mostly Fe₄N with some Fe₃O₄ remaining (FIG. 20). EDS (Table 17) provides a composition of 86-97 at. % Fe, 3-9 at. % O, and 0-6 at. % N.

TABLE 17

| Reactor | Iron at. % | Oxygen at. % | Nitrogen at. % |
|---|---|---|---|
| Position | (Fe Kα) | (O Kα) | (N Kα) |
| Front 1 | 93.9 ± 1 | 3.8 ± 1 | 2.3 ± 1 |
| Front 2 | 88.9 ± 1 | 9.4 ± 1 | 1.8 ± 1 |
| Back 1 | 86.4 ± 1 | 8.0 ± 1 | 5.6 ± 1 |
| Back 2 | 97.2 ± 1 | 2.8 ± 1 | 0.0 ± 1 |
| Bottom 1 | 96.1 ± 1 | 3.3 ± 1 | 0.6 ± 1 |
| Bottom 2 | 96.7 ± 1 | 3.3 ± 1 | 0.0 ± 1 |
| Middle 1 | 96.6 ± 1 | 3.0 ± 1 | 0.5 ± 1 |
| Middle 2 | 94.9 ± 1 | 3.5 ± 1 | 1.5 ± 1 |

Method O, producing iron and iron nitride at 600° C. The quartz boat was charged with 0.232 g (0.95 mmol assuming 5 wt. % gangue) magnetite ore concentrate and loaded into the reactor. The reactor was purged with argon at 40 sccm for 10 minutes. The reactor was then heated under 40 sccm Ar at 20° C./min to 600° C., at which temperature the Ar flow was stopped and a flow of 120 sccm of NH₃ was introduced. After flowing at this rate for 30 minutes, the ammonia flow was stopped and the Ar flow was resumed at 40 sccm. The reactor was cooled at ca. 40° C./min. Yield: 0.144 g (expected for pure Fe with 5 wt. % gangue: 0.171 g).

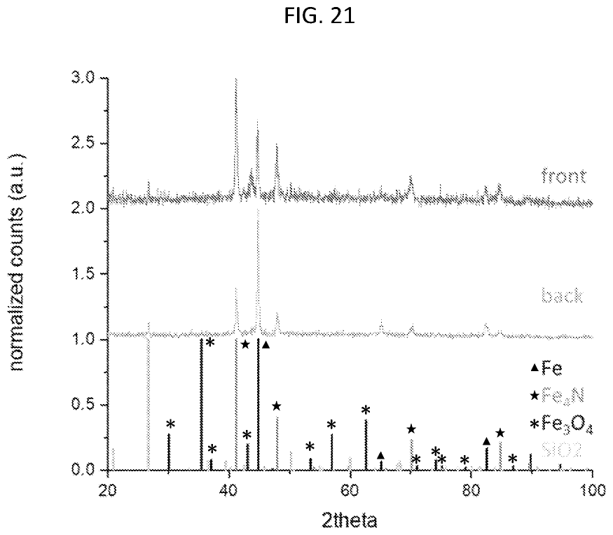

The pXRD pattern shows the crystalline product is mostly Fe with some Fe₄N (FIG. 21). EDS (Table 18) provides a composition of 93-95 at. % Fe, 4-6 at. % O, and 0-2 at. % N.

TABLE 18

| Reactor | Iron at. % | Oxygen at. % | Nitrogen at. % |
|---|---|---|---|
| Position | (Fe Kα) | (O Kα) | (N Kα) |
| Front 1 | 94.2 ± 1 | 5.6 ± 1 | 0.2 ± 1 |
| Front 2 | 94.5 ± 1 | 3.3 ± 1 | 2.2 ± 1 |
| Back 1 | 93.3 ± 1 | 4.7 ± 1 | 2.0 ± 1 |
| Back 2 | 95.5 ± 1 | 4.5 ± 1 | 0.0 ± 1 |
| Bottom 1 | 95.8 ± 1 | 3.1 ± 1 | 1.1 ± 1 |
| Bottom 2 | 95.3 ± 1 | 2.3 ± 1 | 2.3 ± 1 |
| Middle 1 | 95.4 ± 1 | 4.6 ± 1 | 0.0 ± 1 |
| Middle 2 | 94.5 ± 1 | 4.4 ± 1 | 1.1 ± 1 |

Method P, producing iron at 1000° C. The quartz boat was charged with 0.237 g (0.97 mmol assuming 5 wt. % gangue) magnetite ore concentrate and loaded into the reactor. The reactor was purged with argon at 80 sccm for 10 minutes. The reactor was then heated under 80 sccm Ar at 20° C./min to 1000° C., at which temperature the Ar flow was stopped and a flow of 80 sccm of NH₃ was introduced. After flowing at this rate for 1 minute, the ammonia flow was stopped and the Ar flow was resumed at 80 sccm. The reactor was cooled at ca. 40° C./min. Yield: 0.185 g (expected for pure Fe with 5 wt. % gangue: 0.175 g).

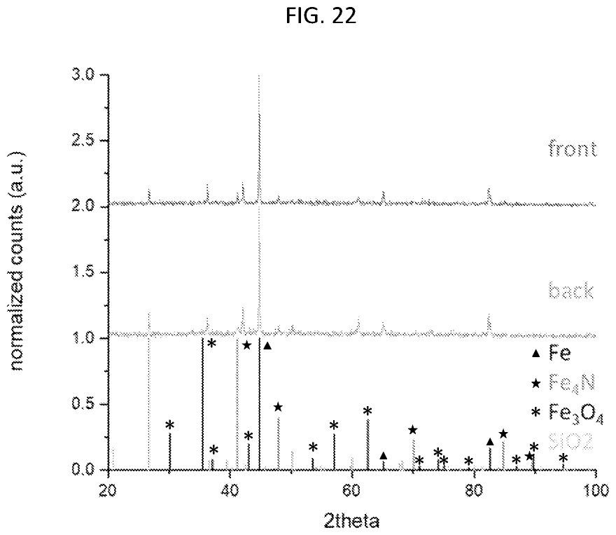

The pXRD pattern shows the crystalline product is mostly Fe with some FeO (FIG. 22). EDS (Table 19) provides a composition of 91-95 at. % Fe, 5-7 at. % O, and 0-2 at. % N.

TABLE 19

| Reactor | Iron at. % | Oxygen at. % | Nitrogen at. % |
|---|---|---|---|
| Position | (Fe Kα) | (O Kα) | (N Kα) |
| Front 1 | 94.9 ± 1 | 5.1 ± 1 | 0.0 ± 1 |
| Front 2 | 93.9 ± 1 | 6.1 ± 1 | 0.0 ± 1 |
| Back 1 | 91.4 ± 1 | 6.9 ± 1 | 1.7 ± 1 |
| Back 2 | 92.4 ± 1 | 6.6 ± 1 | 1.0 ± 1 |
| Bottom 1 | 94.6 ± 1 | 5.4 ± 1 | 0.0 ± 1 |
| Bottom 2 | 94.0 ± 1 | 6.0 ± 1 | 0.0 ± 1 |
| Middle 1 | 93.5 ± 1 | 6.6 ± 1 | 0.0 ± 1 |
| Middle 2 | 95.5 ± 1 | 4.5 ± 1 | 0.0 ± 1 |

### Example 8. Using Nitrogen as a Cooling Gas

Nitrogen provides a less expensive alternative to argon as a heating and cooling gas. In general, we observe similar results when using nitrogen and argon. Method K, below, is identical to Method A except that nitrogen is used as the heating and cooling gas instead of argon.

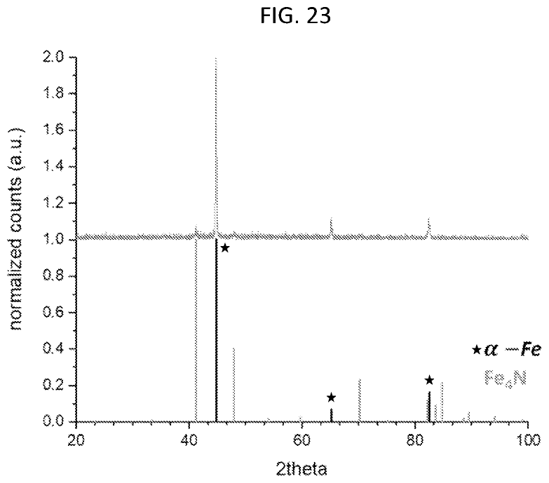

Method Q, producing iron at 700° C., using nitrogen as a heating and cooling gas. The quartz boat was charged with 0.167 g (1.05 mmol) of iron(III) oxide powder and loaded into the reactor. The reactor was purged with nitrogen at 40 sccm for 10 minutes. The reactor was then heated under 120 sccm N₂ at 20° C./min to 700° C., at which temperature the N₂ flow was stopped and a flow of 40 sccm of NH₃ was introduced. After flowing at this rate for 10 minutes, the ammonia flow was stopped and the N₂ flow was resumed at 120 sccm. The reactor was cooled at ca. 40° C./min. Yield: 0.122 g (expected for pure Fe: 0.117 g). The pXRD pattern in FIG. 23 reveals iron with a small amount of iron nitride present. EDS composition (Table 20): 95-100 at. % Fe, 0-1 at. % O, and 0-4 at. % N. The results are similar to the results of Method A (FIG. 3).

TABLE 20

| Reactor | Iron at. % | Oxygen at. % | Nitrogen at. % |
|---|---|---|---|
| Position | (Fe Kα) | (O Kα) | (N Kα) |
| Front 1 | 100 ± 1 | 0 ± 1 | 0 ± 1 |
| Front 2 | 98 ± 1 | 0 ± 1 | 1 ± 1 |
| Back 1 | 99 ± 1 | 1 ± 1 | 1 ± 1 |
| Back 2 | 98 ± 1 | 1 ± 1 | 1 ± 1 |
| Bottom 1 | 95 ± 1 | 1 ± 1 | 4 ± 1 |
| Bottom 2 | 99 ± 1 | 0 ± 1 | 1 ± 1 |

### Example 9. Reduction of Metal Oxides with Ammonia

Based on thermodynamic calculations, we imagined that several other industrially relevant metals could be produced from their oxides using ammonia. These metals include molybdenum, tungsten, cobalt, nickel, copper, zinc, cadmium, mercury, indium, thallium, germanium, tin, lead, and bismuth. Only the reduction of copper oxide and nickel oxide with ammonia have been reported previously.

In addition to the reduction of iron(III) oxide, we have demonstrated the complete reduction to the metal of copper(II) oxide, nickel(II) oxide, cobalt(II,III) oxide, tungsten(VI) oxide, and tin(IV) oxide by ammonia; the conditions required depend on the metal. We have also reduced zinc(II) oxide to the metal, although we have not been able to isolate the zinc metal (see below).

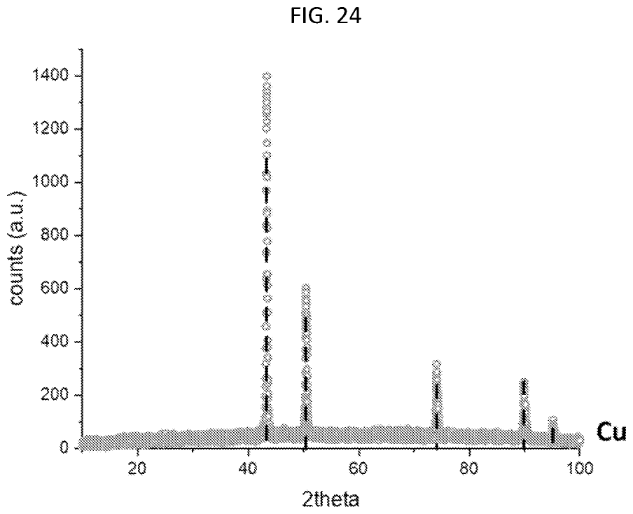

Method R, reduction of copper(II) oxide. The quartz boat was charged with 0.081 g (1.02 mmol) of copper(II) oxide and loaded into the reactor. The reactor was purged with argon at 40 sccm for 10 minutes. The reactor was then heated under 40 sccm Ar at 20° C./min to 500° C., at which temperature the Ar flow was stopped and a flow of 40 sccm of NH₃ was introduced. After flowing at this rate for 30 minutes, the ammonia flow was stopped and the Ar flow was resumed at 40 sccm. The reactor was cooled at ca. 40° C./min. Yield: 0.061 g (expected for pure Cu: 0.065 g). The pXRD pattern shown in FIG. 24 shows the product is pure Cu. EDS composition: 99-100 at. % Cu, 0-1 at. % O, 0-1 at. % N. We anticipate that reaction time and temperature may be further decreased for this reduction.

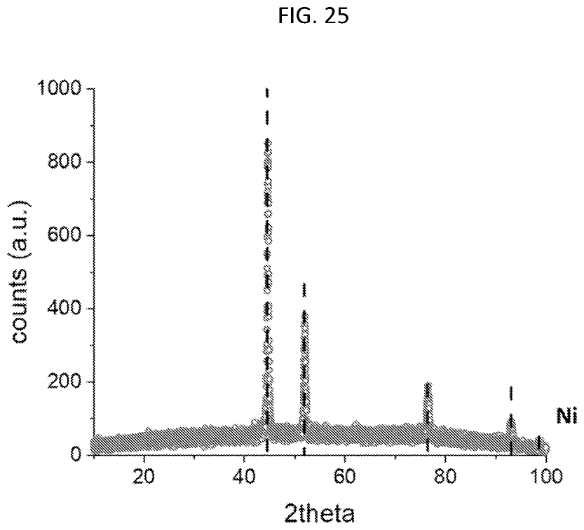

Method S, Variant 1, reduction of nickel(II) oxide at 500° C. The quartz boat was charged with 0.075 g (1.00 mmol) of nickel(II) oxide and loaded into the reactor. The reactor was purged with argon at 40 sccm for 10 minutes. The reactor was then heated under 40 sccm Ar at 20° C./min to 500° C., at which temperature the Ar flow was stopped and a flow of 40 sccm of NH₃ was introduced. After flowing at this rate for 30 minutes, the ammonia flow was stopped and the Ar flow was resumed at 40 sccm. The reactor was cooled at ca. 40° C./min. Yield: 0.0595 g (expected for pure Ni: 0.0596 g). The pXRD pattern in FIG. 25 shows the product is pure Ni. EDS composition (Table 21): 96-100 at. % Ni, 0-1 at. % O, 0-3 at. % N.

TABLE 21

| Reactor | Nickel at. % | Oxygen at. % | Nitrogen at. % |
|---|---|---|---|
| Position | (Ni Kα) | (O Kα) | (N Kα) |
| Front 1 | 100 ± 1 | 0 ± 1 | 0 ± 1 |
| Front 2 | 99 ± 1 | 0 ± 1 | 1 ± 1 |
| Back 1 | 98 ± 1 | 0 ± 1 | 2 ± 1 |
| Back 2 | 96 ± 1 | 1 ± 1 | 3 ± 1 |

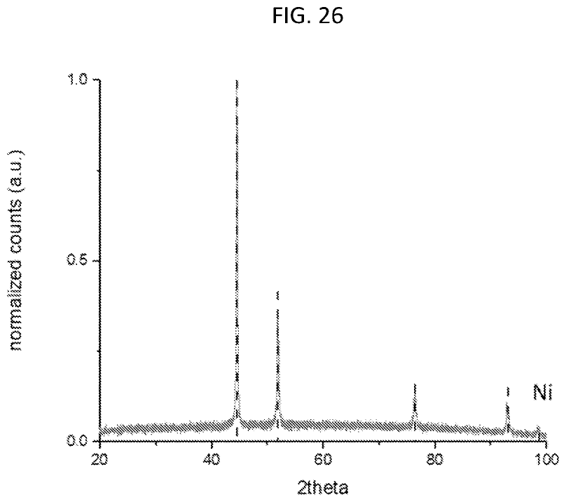

Method S, Variant 2, reduction of nickel(II) oxide at 400° C. The quartz boat was charged with 0.075 g (1.00 mmol) of nickel(II) oxide and loaded into the reactor. The reactor was purged with argon at 40 sccm for 10 minutes. The reactor was then heated under 40 sccm Ar at 20° C./min to 400° C., at which temperature the Ar flow was stopped and a flow of 40 sccm of NH₃ was introduced. After flowing at this rate for 30 minutes, the ammonia flow was stopped and the Ar flow was resumed at 40 sccm. The reactor was cooled at ca. 40° C./min. Yield: 0.0541 g (expected for pure Ni: 0.0596 g). The pXRD pattern in FIG. 26 shows the product is pure Ni. EDS composition (Table 22): 98-100 at. % Ni, 0-2 at. % O, 0 at. % N. We anticipate that reaction time and temperature may be further decreased for this reduction.

TABLE 22

| Reactor | Nickel at. % | Oxygen at. % | Nitrogen at. % |
|---|---|---|---|
| Position | (Ni Kα) | (O Kα) | (N Kα) |
| Front 1 | 99.4 ± 1 | 0.3 ± 1 | 0.2 ± 1 |
| Front 2 | 98.6 ± 1 | 1.4 ± 1 | 0.0 ± 1 |
| Back 1 | 100.0 ± 1 | 0.0 ± 1 | 0.0 ± 1 |
| Back 2 | 98.1 ± 1 | 1.9 ± 1 | 0.0 ± 1 |
| Bottom 1 | 99.2 ± 1 | 0.9 ± 1 | 0.0 ± 1 |
| Bottom 2 | 98.9 ± 1 | 1.1 ± 1 | 0.0 ± 1 |
| Middle 1 | 98.1 ± 1 | 1.9 ± 1 | 0.0 ± 1 |
| Middle 2 | 98.8 ± 1 | 1.2 ± 1 | 0.0 ± 1 |

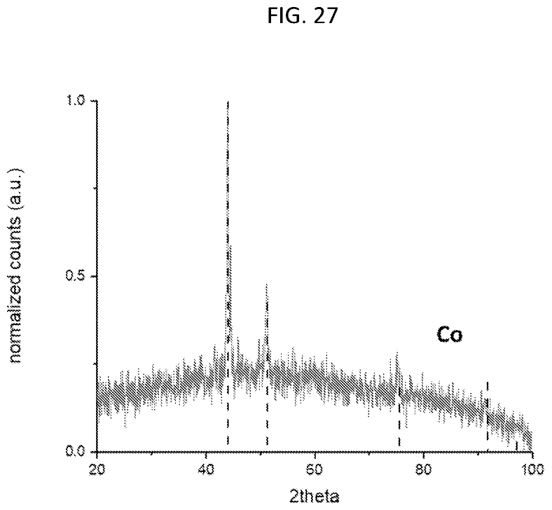

Method T, reduction of cobalt(II, III) oxide. The quartz boat was charged with 0.241 g (1.00 mmol) of cobalt(II,III) oxide and loaded into the reactor. The reactor was purged with argon at 40 sccm for 10 minutes. The reactor was then heated under 40 sccm Ar at 20° C./min to 500° C., at which temperature the Ar flow was stopped and a flow of 40 sccm of NH₃ was introduced. After flowing at this rate for 30 minutes, the ammonia flow was stopped and the Ar flow was resumed at 40 sccm. The reactor was cooled at ca. 40° C./min. Yield: 0.181 g (expected for pure Co: 0.177 g). The pXRD pattern in FIG. 27 shows only a relatively weak diffraction peak for cobalt metal. The large background signal owing to X-ray fluorescence induced by the Cu Kα beam makes identification less reliable for this sample. However, the EDS data (Table 23) support full reduction; the sample is 97-98 at. % Co, 1 at. % O, and 1-2 at. % N. We anticipate that reaction time and temperature may be further decreased for this reduction.

Some samples produced by this method also show full reduction, but incorporate larger amounts of nitrogen by EDS (Table 24), such as 88-94 at. % Co, 1-3 at. % O, and 3-9 at. % N.

TABLE 23

| Reactor | Cobalt at. % | Oxygen at. % | Nitrogen at. % |
|---|---|---|---|
| Position | (Co Kα) | (O Kα) | (N Kα) |
| Front | 98 ± 1 | 1 ± 1 | 1 ± 1 |
| Back | 97 ± 1 | 1 ± 1 | 2 ± 1 |
| Bottom | 98 ± 1 | 1 ± 1 | 2 ± 1 |

TABLE 24

| Reactor | Cobalt at. % | Oxygen at. % | Nitrogen at. % |
|---|---|---|---|
| Position | (Co Kα) | (O Kα) | (N Kα) |
| Front 1 | 95.4 ± 1 | 0.7 ± 1 | 3.9 ± 1 |
| Front 2 | 88.4 ± 1 | 3.2 ± 1 | 8.4 ± 1 |
| Back 1 | 93.6 ± 1 | 0.8 ± 1 | 5.6 ± 1 |
| Back 2 | 87.8 ± 1 | 2.8 ± 1 | 9.3 ± 1 |
| Bottom 1 | 95.9 ± 1 | 0.9 ± 1 | 3.2 ± 1 |
| Bottom 2 | 91.1 ± 1 | 2.4 ± 1 | 6.6 ± 1 |
| Middle 1 | 91.2 ± 1 | 3.1 ± 1 | 5.7 ± 1 |
| Middle 2 | 93.9 ± 1 | 1.1 ± 1 | 5.0 ± 1 |

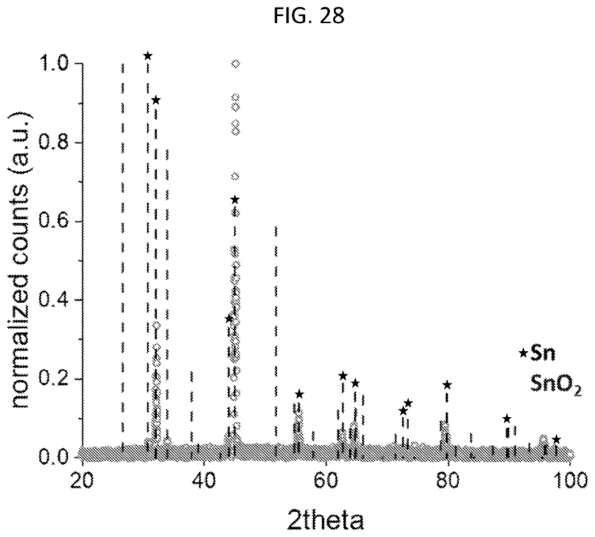

Method U, reduction of tin(IV) oxide. A ceramic boat (45 mm×5 mm×5 mm) was charged with 0.150 g (1.00 mmol) of tin(IV) oxide and loaded into the reactor. The reactor was purged with argon at 80 sccm for 5 minutes. The reactor was then heated under 80 sccm Ar at 20° C./min to 800° C., at which temperature the Ar flow was stopped and a flow of 80 sccm of NH₃ was introduced. After flowing at this rate for 30 minutes, the ammonia flow was stopped and the Ar flow was resumed at 80 sccm. The reactor was cooled at ca. 40° C./min. Yield: 0.112 g (expected for pure Sn: 0.118 g). Because the reaction temperature exceeded the melting point of tin metal (231° C.), the product formed beads of molten metal that solidified as the reactor cooled. These beads seem to expel tin oxide to their surface. The pXRD pattern shown in FIG. 28 shows the crystalline product is pure Sn. The EDS data of the bead exterior is consistent with an oxide layer on the outer surface of the metallic tin beads that form during the reaction. Approximately 9-14 at. % O is present on the surface of the tin beads (balance Sn). However, when the beads are cross-sectioned under a microscope and the bead interior probed by EDS, the composition is 100 at. % Sn and 0 at. % O.

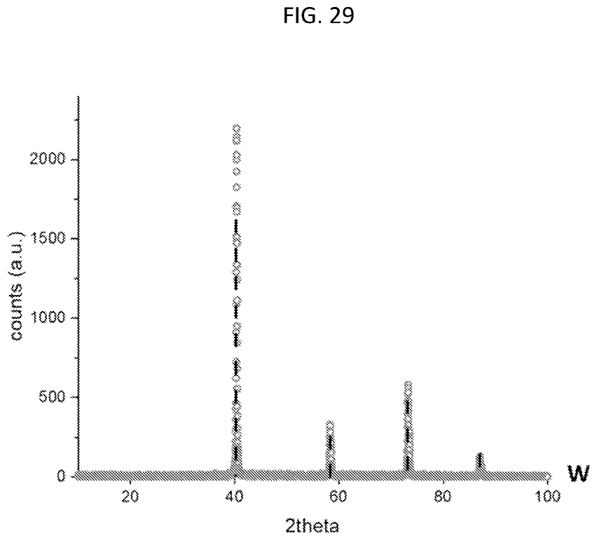

Method V, reduction of tungsten(VI) oxide. The quartz boat was charged with 0.235 g (1.01 mmol) of tungsten(VI) oxide and loaded into the reactor. The reactor was purged with argon at 120 sccm for 5 minutes. The reactor was then heated under 120 sccm Ar at 20° C./min to 1000° C., at which temperature the Ar flow was stopped and a flow of 120 sccm of NH₃ was introduced. After flowing at this rate for 30 minutes, the ammonia flow was stopped and the Ar flow was resumed at 120 sccm. The reactor was cooled at ca. 40° C./min. Yield: 0.186 g (expected for pure W: 0.186 g). The pXRD pattern in FIG. 29 shows the product is pure W. EDS composition (Table 25): 98-100 at. % W, 0-2 at. % O, 0 at. % N.

TABLE 25

| Reactor | Tungsten at. % | Oxygen at. % | Nitrogen at. % |
|---|---|---|---|
| Position | (W Kα) | (O Kα) | (N Kα) |
| Front 1 | 100 ± 1 | 0 ± 1 | 0 ± 1 |
| Front 2 | 98 ± 1 | 2 ± 1 | 0 ± 1 |
| Back 1 | 100 ± 1 | 0 ± 1 | 0 ± 1 |
| Back 2 | 99 ± 1 | 1 ± 1 | 0 ± 1 |
| Bottom 1 | 98 ± 1 | 2 ± 1 | 0 ± 1 |
| Bottom 2 | 100 ± 1 | 0 ± 1 | 0 ± 1 |

Method W, reduction of zinc(II) oxide. The quartz boat was charged with 0.093 g (1.15 mmol) of zinc(II) oxide and loaded into the reactor. The reactor was purged with ammonia at 40 sccm for 10 minutes. The reactor was then heated under 40 sccm NH₃ at 25° C./min to 1000° C. and after flowing at this rate for 30 minutes, the reactor was cooled at ca. 40° C./min under 40 sccm NH₃. Due to the high volatility of zinc metal at 1000° C., the product was transported by the gas flow and deposited on the walls of the tube and on a ceramic plug at the reactor outlet. No material was left in the quartz boat. Although some metallic-gray solids were observed on the tube walls, the majority of the deposited material was white, and the material on the ceramic plug appeared to be zinc oxide by EDS. Because zinc(II) oxide (melting point=1975° C.) is not volatile, the transport of the zinc oxide is believed to occur through zinc metal (melting point=420° C.). That is, the ammonia reduces zinc(II) oxide to zinc metal, which then evaporates (boiling point=907° C.) and is transported towards the reactor outlet. In the process, water vapor byproduct re-oxidizes the zinc, depositing zinc(II) oxide on the colder walls near the reactor outlet. We anticipate that further optimization of the process parameters would allow separation of the zinc vapor and water vapor, e.g., by fractional distillation.

### Example 10. Reduction of FeO, Fe₃O₄, and FeO(OH)

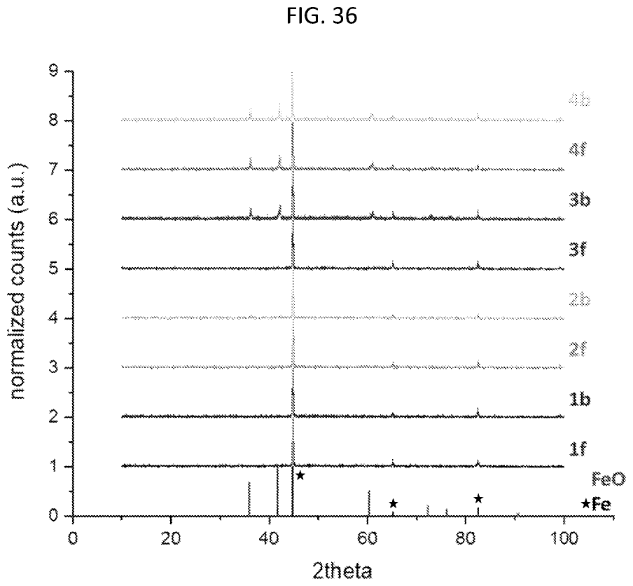

Method X. Iron oxide (FeO or Fe₃O₄) was added to a reactor and the interior of the reactor was heated to 1000° C. at a rate of 20° C./min using inert gas (argon) at a flow rate of 80 sccm. Ammonia was introduced to the reactor at a rate of 80 sccm and the reactor was held at 1000° C. for 5 minutes and then argon was introduced to cool the reactor at a rate of 80 sccm. Comparison to reduction of Fe₂O₃ is provided. Powder X-ray diffraction results in FIG. 36 show pure iron is produced in all three cases. EDS compositions, by starting oxide: Fe₂O₃ (Table 26), 98-100 at. % Fe, 0 at. % O, 0-1 at. % N; Fe₃O₄ (Table 27), 98-100 at. % Fe, 0 at. % O, 0-1 at. % N; FeO (Table 28), 98-100 at. % Fe, 0 at. % O, 0-1 at. % N.

TABLE 26

| Reactor | Iron at. % | Oxygen at. % | Nitrogen at. % |
|---|---|---|---|
| Position | (Fe Kα) | (O Kα) | (N Kα) |
| Front 1 | 100 ± 1 | 0 ± 1 | 0 ± 1 |
| Front 2 | 100 ± 1 | 0 ± 1 | 0 ± 1 |
| Back 1 | 100 ± 1 | 0 ± 1 | 0 ± 1 |
| Back 2 | 100 ± 1 | 0 ± 1 | 0 ± 1 |
| Bottom 1 | 98 ± 1 | 0 ± 1 | 1 ± 1 |
| Bottom 2 | 99 ± 1 | 0 ± 1 | 1 ± 1 |

TABLE 27

| Reactor | Iron at. % | Oxygen at. % | Nitrogen at. % |
|---|---|---|---|
| Position | (Fe Kα) | (O Kα) | (N Kα) |
| Front 1 | 98 ± 1 | 2 ± 1 | 0 ± 1 |
| Front 2 | 100 ± 1 | 0 ± 1 | 0 ± 1 |
| Back 1 | 99 ± 1 | 1 ± 1 | 0 ± 1 |
| Back 2 | 98 ± 1 | 2 ± 1 | 0 ± 1 |
| Bottom 1 | 100 ± 1 | 0 ± 1 | 0 ± 1 |
| Bottom 2 | 100 ± 1 | 0 ± 1 | 0 ± 1 |

TABLE 28

| Reactor | Iron at. % | Oxygen at. % | Nitrogen at. % |
|---|---|---|---|
| Position | (Fe Kα) | (O Kα) | (N Kα) |
| Top 1 | 97 ± 1 | 3 ± 1 | 0 ± 1 |
| Top 2 | 92 ± 1 | 7 ± 1 | 0 ± 1 |
| Top 3 | 96 ± 1 | 4 ± 1 | 0 ± 1 |
| Bottom 1 | 97 ± 1 | 3 ± 1 | 0 ± 1 |
| Bottom 2 | 99 ± 1 | 1 ± 1 | 0 ± 1 |
| Bottom 3 | 99 ± 1 | 1 ± 1 | 0 ± 1 |

Method Y, producing iron nitride, ε-Fe₃N, from Fe₃O₄ at 700° C. The quartz boat was charged with 0.236 g (1.02 mmol) of iron(II,III) oxide and loaded into the reactor. The reactor was purged with argon at 40 sccm for 5 minutes. The reactor was then heated under 40 sccm Ar at 20° C./min to 700° C., at which temperature the Ar flow was stopped and a flow of 40 sccm of NH₃ was introduced. After flowing at this rate for 10 minutes, the ammonia flow was stopped and the Ar flow was resumed at 40 sccm. The reactor was cooled at ca. 40° C./min. Yield: 0.176 g (expected for pure Fe: 0.171 g; expected for pure Fe₃N: 0.185 g).

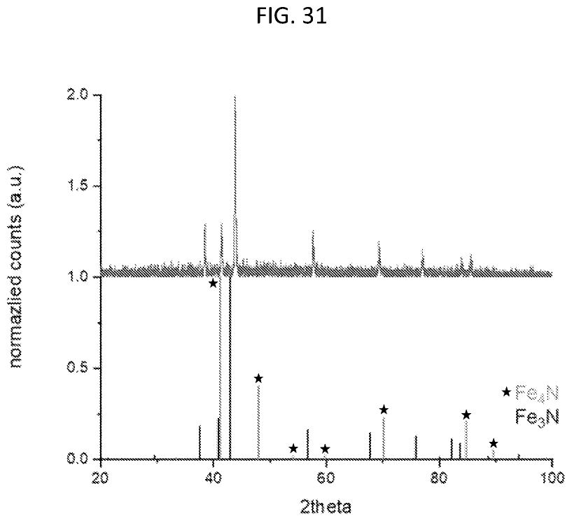

The pXRD pattern (FIG. 31) shows the crystalline product is Fe₃N. EDS (Table 29) provides a composition of 94-99 at. % Fe, 0-1 at. % O, and 1-6 at. % N.

TABLE 29

| Reactor | Iron at. % | Oxygen at. % | Nitrogen at. % |
|---|---|---|---|
| Position | (Fe Kα) | (O Kα) | (N Kα) |
| Front 1 | 98.8 ± 1 | 0.4 ± 1 | 0.8 ± 1 |
| Front 2 | 96.6 ± 1 | 0.4 ± 1 | 3.0 ± 1 |
| Back 1 | 94.2 ± 1 | 0.1 ± 1 | 5.6 ± 1 |
| Back 2 | 98.6 ± 1 | 0.4 ± 1 | 1.0 ± 1 |

Method Z, producing a mixture of iron and iron nitride from FeO(OH) at 700° C. The quartz boat was charged with 0.089 g (1.00 mmol) of iron(III) oxide-hydroxide and loaded into the reactor. The reactor was purged with argon at 120 sccm for 5 minutes. The reactor was then heated under 120 sccm Ar at 20° C./min to 700° C., at which temperature the Ar flow was stopped and a flow of 40 sccm of NH₃ was introduced. After flowing at this rate for 10 minutes, the ammonia flow was stopped and the Ar flow was resumed at 120 sccm. The reactor was cooled at ca. 40° C./min. Yield: 0.063 g (expected for pure Fe: 0.056 g; expected for pure Fe₃N: 0.061 g)

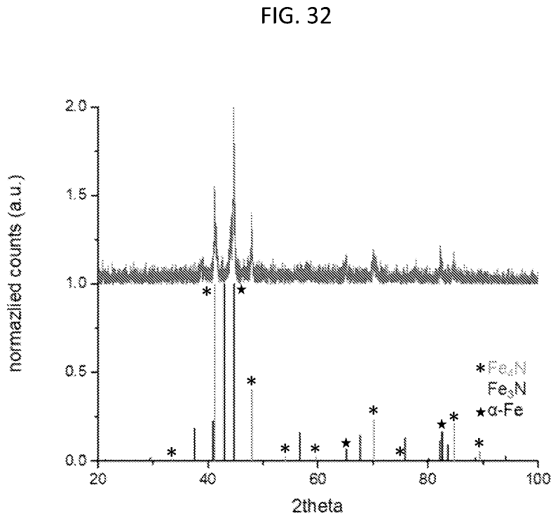

The pXRD pattern (FIG. 32) shows the crystalline product is a mixture of α-Fe and γ′-Fe₄N, possibly with a small amount of ε-Fe₃N. EDS (Table 30) provides a composition of 96-97 at. % Fe, 2-4 at. % O, and 0-2 at. % N.

TABLE 30

| Reactor | Iron at. % | Oxygen at. % | Nitrogen at. % |
|---|---|---|---|
| Position | (Fe Kα) | (O Kα) | (N Kα) |
| Front 1 | 96.8 ± 1 | 3.2 ± 1 | 0.0 ± 1 |
| Front 2 | 96.8 ± 1 | 1.8 ± 1 | 1.4 ± 1 |
| Back 1 | 97.2 ± 1 | 2.8 ± 1 | 0.0 ± 1 |
| Back 2 | 97.8 ± 1 | 2.8 ± 1 | 3.6 ± 1 |
| Bottom 1 | 96.5 ± 1 | 3.5 ± 1 | 0.0 ± 1 |
| Bottom 2 | 96.5 ± 1 | 3.5 ± 1 | 0.0 ± 1 |
| Middle 1 | 97.2 ± 1 | 2.9 ± 1 | 0.0 ± 1 |
| Middle 2 | 97.2 ± 1 | 2.9 ± 1 | 0.0 ± 1 |

Method α, producing iron nitride, ε-Fe₃N, from FeO(OH) at 700° C. The quartz boat was charged with 0.089 g (1.00 mmol) of iron(III) oxide-hydroxide and loaded into the reactor. The reactor was purged with argon at 40 sccm for 10 minutes. The reactor was then heated under 40 sccm Ar at 20° C./min to 700° C., at which temperature the Ar flow was stopped and a flow of 40 sccm of NH₃ was introduced. After flowing at this rate for 5 minutes, the ammonia flow was stopped and the Ar flow was resumed at 40 sccm. The reactor was cooled at ca. 40° C./min. Yield: 0.064 g (expected for pure Fe: 0.056 g; expected for pure Fe₃N: 0.061 g)

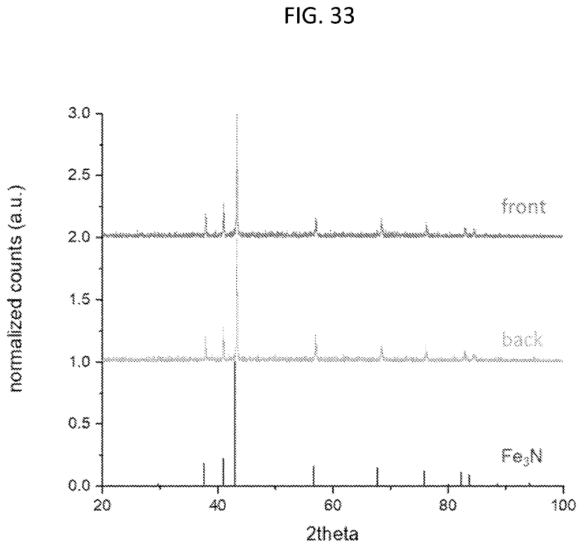

The pXRD pattern (FIG. 33) shows the crystalline product is pure ε-Fe₃N. EDS (Table 31) provides a composition of 94-97 at. % Fe, 2-4 at. % O, and 0-3 at. % N.

TABLE 31

| Reactor | Iron at. % | Oxygen at. % | Nitrogen at. % |
|---|---|---|---|
| Position | (Fe Kα) | (O Kα) | (N Kα) |
| Front 1 | 94.4 ± 1 | 2.8 ± 1 | 2.8 ± 1 |
| Front 2 | 94.9 ± 1 | 4.5 ± 1 | 0.6 ± 1 |
| Back 1 | 93.5 ± 1 | 3.2 ± 1 | 3.3 ± 1 |
| Back 2 | 95.2 ± 1 | 2.7 ± 1 | 2.1 ± 1 |
| Bottom 1 | 96.0 ± 1 | 2.0 ± 1 | 2.0 ± 1 |
| Bottom 2 | 95.2 ± 1 | 2.5 ± 1 | 2.3 ± 1 |
| Middle 1 | 97.4 ± 1 | 2.6 ± 1 | 0.0 ± 1 |
| Middle 2 | 94.9 ± 1 | 3.2 ± 1 | 1.9 ± 1 |

Method β, producing iron nitride, ε-Fe₃N, from FeO(OH) at 600° C. The quartz boat was charged with 0.178 g (2.00 mmol) of iron(III) oxide-hydroxide and loaded into the reactor. The reactor was purged with argon at 120 sccm for 5 minutes. The reactor was then heated under 120 sccm Ar at 20° C./min to 600° C., at which temperature the Ar flow was stopped and a flow of 120 sccm of NH₃ was introduced. After flowing at this rate for 10 minutes, the ammonia flow was stopped and the Ar flow was resumed at 120 sccm. The reactor was cooled at ca. 40° C./min. Yield: 0.128 g (expected for pure Fe: 0.112 g; expected for pure Fe₃N: 0.121 g)

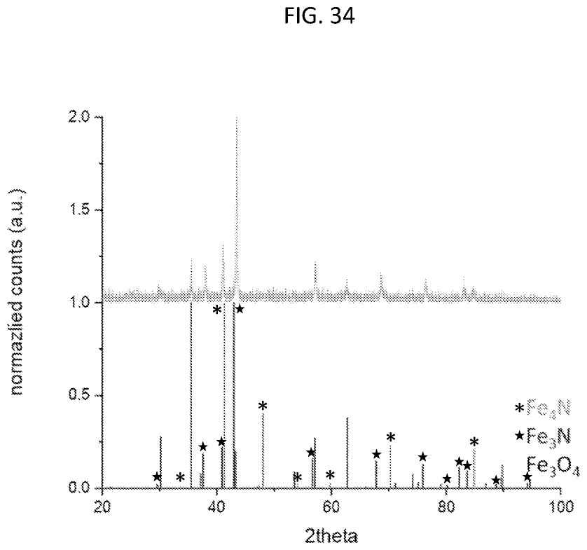

The pXRD pattern (FIG. 34) shows the crystalline product is ε-Fe₃N, with some Fe₃O₄. EDS (Table 32) provides a composition of 88-95 at. % Fe, 4-7 at. % O, and 0-7 at. % N.

TABLE 32

| Reactor | Iron at. % | Oxygen at. % | Nitrogen at. % |
|---|---|---|---|
| Position | (Fe Kα) | (O Kα) | (N Kα) |
| Front 1 | 95.1 ± 1 | 4.5 ± 1 | 0.4 ± 1 |
| Front 2 | 88.0 ± 1 | 4.8 ± 1 | 7.3 ± 1 |
| Back 1 | 92.6 ± 1 | 7.4 ± 1 | 0.0 ± 1 |
| Back 2 | 94.5 ± 1 | 4.1 ± 1 | 1.3 ± 1 |
| Bottom 1 | 94.7 ± 1 | 5.3 ± 1 | 0.0 ± 1 |
| Bottom 2 | 94.6 ± 1 | 3.9 ± 1 | 1.5 ± 1 |
| Middle 1 | 94.4 ± 1 | 5.6 ± 1 | 0.0 ± 1 |
| Middle 2 | 93.6 ± 1 | 6.5 ± 1 | 0.0 ± 1 |

### Example 11. Pulsed Reduction of Iron(III) Oxide

Method γ. The full sample charge of 1.598 g (10.0 mmol) of iron(III) oxide was divided among 4 quartz boats and loaded into the reactor, with approximately 0.400 g in each boat. The reactor was purged with argon at 200 sccm for 5 minutes. The reactor was then heated under 200 sccm Ar at 20° C./min to 1000° C., at which temperature the Ar flow was stopped and a flow of 200 sccm of NH₃ was introduced. The NH₃ was supplied for 1 minute and then stopped, and the Ar flow of 200 sccm was resumed for 1 minute. This pulse sequence was repeated 3 more times, for a total ammonia delivery of 800 mL, distributed amongst the 4 pulses. That is, the pulse sequence at 1000° C. was NH₃/Ar/NH₃/Ar/NH₃/Ar/NH₃/then Ar to cool.

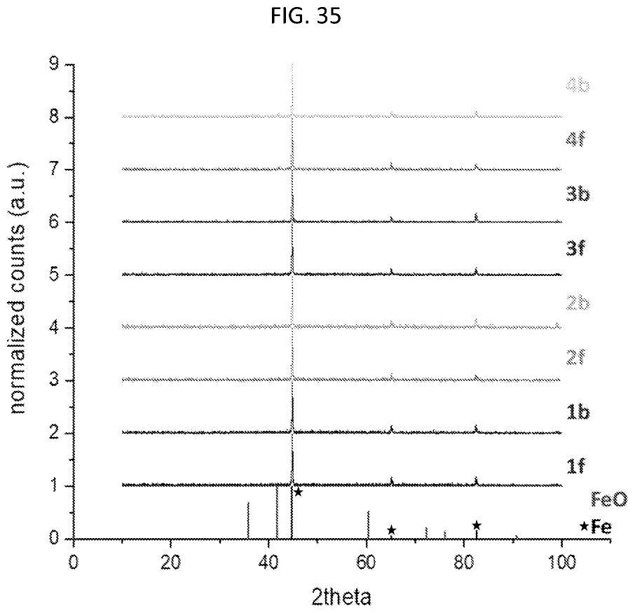

The reactor was cooled at ca. 40° C./min under 200 sccm Ar. Yield: 1.121 g (expected for pure Fe: 1.118 g). The pXRD patterns in FIG. 35 show the product is pure α-Fe throughout the samples. EDS (Table 33) provides a composition of 98-100 at. % Fe, 0-2 at. % O, and 0-1 at. % N across the boats. In this reaction, 800 mL NH₃ (35.7 mmol) were delivered; 20.0 mmol were needed for complete reduction of Fe₂O₃ to 2 Fe, implying 56% of the NH₃ delivered was used to produce iron.

TABLE 33

| Reactor | Iron at. % | Oxygen at. % | Nitrogen at. % |
|---|---|---|---|
| Position | (Fe Kα) | (O Kα) | (N Kα) |
| Boat 1, front 1 | 99 ± 1 | 0 ± 1 | 1 ± 1 |
| Boat 1, front 2 | 99 ± 1 | 0 ± 1 | 1 ± 1 |
| Boat 1, back 1 | 99 ± 1 | 0 ± 1 | 1 ± 1 |
| Boat 1, back 2 | 100 ± 1 | 0 ± 1 | 0 ± 1 |
| Boat 2, front 1 | 99 ± 1 | 0 ± 1 | 1 ± 1 |
| Boat 2, front 2 | 100 ± 1 | 0 ± 1 | 0 ± 1 |
| Boat 2, back 1 | 99 ± 1 | 1 ± 1 | 0 ± 1 |
| Boat 2, back 2 | 99 ± 1 | 0 ± 1 | 1 ± 1 |
| Boat 3, front 1 | 100 ± 1 | 0 ± 1 | 0 ± 1 |
| Boat 3, front 2 | 100 ± 1 | 0 ± 1 | 0 ± 1 |
| Boat 3, back 1 | 99 ± 1 | 0 ± 1 | 1 ± 1 |
| Boat 3, back 2 | 100 ± 1 | 0 ± 1 | 0 ± 1 |
| Boat 4, front 1 | 99 ± 1 | 0 ± 1 | 0 ± 1 |
| Boat 4, front 2 | 100 ± 1 | 0 ± 1 | 0 ± 1 |
| Boat 4, back 1 | 99 ± 1 | 1 ± 1 | 0 ± 1 |
| Boat 4, back 2 | 98 ± 1 | 2 ± 1 | 0 ± 1 |

Method δ. The full sample charge of 1.600 g (10.0 mmol) of iron(III) oxide was divided among 4 quartz boats and loaded into the reactor, with approximately 0.400 g in each boat. The reactor was purged with argon at 200 sccm for 5 minutes. The reactor was then heated under 200 sccm Ar at 20° C./min to 1000° C., at which temperature the Ar flow was stopped and a flow of 400 sccm of NH₃ was introduced. The NH₃ was supplied for 1 minute and then stopped, and the Ar flow of 200 sccm was resumed for 1 minute. The NH₃ flow was resumed (400 sccm) for 1 minute and then stopped, and the Ar flow (200 sccm) was resumed. A total of 800 mL of ammonia were delivered, divided across the two 1-minute pulses. The reactor was cooled at ca. 40° C./min under 200 sccm Ar. Yield: 1.207 g (expected for pure Fe: 1.119 g). The pXRD patterns in FIG. 36 show the product is pure α-Fe through boats 1 and 2, with FeO and Fe present in boats 3 and 4. EDS (Table 34) provides a composition of 78-100 at. % Fe, 0-17 at. % O, and 0-5 at. % N across the boats.

TABLE 34

| Reactor | Iron at. % | Oxygen at. % | Nitrogen at. % |
|---|---|---|---|
| Position | (Fe Kα) | (O Kα) | (N Kα) |
| Boat 1, front 1 | 100 ± 1 | 0 ± 1 | 0 ± 1 |
| Boat 1, front 2 | 99 ± 1 | 1 ± 1 | 0 ± 1 |
| Boat 1, back 1 | 100 ± 1 | 0 ± 1 | 0 ± 1 |
| Boat 1, back 2 | 100 ± 1 | 0 ± 1 | 0 ± 1 |
| Boat 2, front 1 | 100 ± 1 | 0 ± 1 | 0 ± 1 |
| Boat 2, front 2 | 100 ± 1 | 0 ± 1 | 0 ± 1 |
| Boat 2, back 1 | 100 ± 1 | 0 ± 1 | 0 ± 1 |
| Boat 2, back 2 | 100 ± 1 | 0 ± 1 | 0 ± 1 |
| Boat 3, front 1 | 99 ± 1 | 0 ± 1 | 0 ± 1 |
| Boat 3, front 2 | 100 ± 1 | 0 ± 1 | 0 ± 1 |
| Boat 3, back 1 | 98 ± 1 | 2 ± 1 | 0 ± 1 |
| Boat 3, back 2 | 98 ± 1 | 2 ± 1 | 0 ± 1 |
| Boat 4, front 1 | 92 ± 1 | 7 ± 1 | 1 ± 1 |
| Boat 4, front 2 | 99 ± 1 | 1 ± 1 | 0 ± 1 |
| Boat 4, back 1 | 78 ± 1 | 17 ± 1 | 5 ± 1 |
| Boat 4, back 2 | 84 ± 1 | 15 ± 1 | 1 ± 1 |

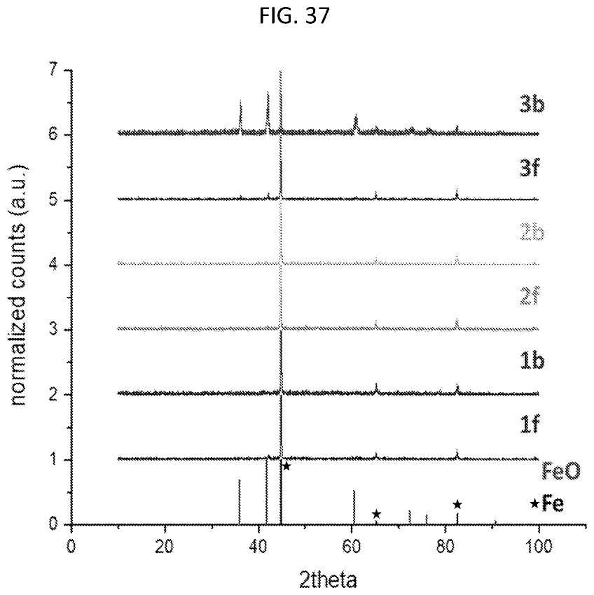

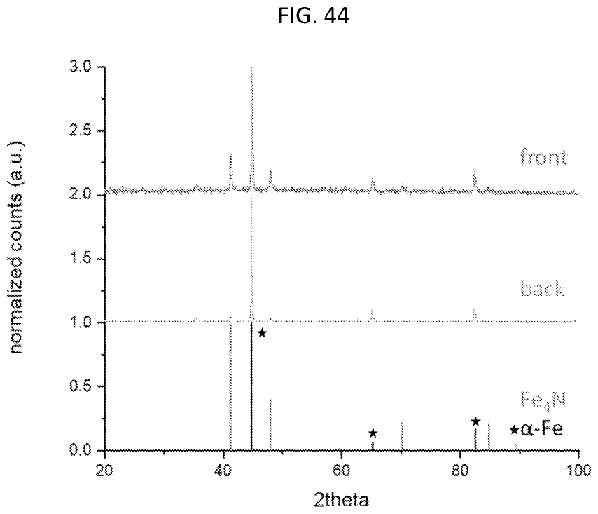

Method ε. The full sample charge of 1.601 g (10.0 mmol) of iron(III) oxide was divided among 3 quartz boats and loaded into the reactor, with approximately 0.533 g in each boat. A 4^{th} empty boat was placed in the reactor as shown in FIG. 44 to ensure the same amount of space was taken up by each boat as for comparable reductions at this scale. The reactor was purged with argon at 200 sccm for 5 minutes. The reactor was then heated under 200 sccm Ar at 20° C./min to 1000° C., at which temperature the Ar flow was stopped and a flow of 400 sccm of NH₃ was introduced. The NH₃ was supplied for 1 minute and then stopped, and the Ar flow (200 sccm) resumed. After 1 minute, the Ar flow was stopped and NH₃ was supplied again for 1 minute at 400 sccm. After 1 minute, the NH₃ flow was stopped and the Ar flow resumed. A total of 800 mL of ammonia were delivered, divided across the two 1-minute pulses. The reactor was cooled at ca. 40° C./min under 200 sccm Ar. Yield: 1.176 g (expected for pure Fe: 1.120 g). The pXRD patterns in FIG. 37 show the product is pure α-Fe through the majority of boats 1-3, with both FeO and Fe present in the boat nearest to the outlet. EDS (Table 35) provides a composition of 93-100 at. % Fe, 0-7 at. % O, and 0 at. % N across the boats.

TABLE 35

| Reactor | Iron at. % | Oxygen at. % | Nitrogen at. % |
|---|---|---|---|
| Position | (Fe Kα) | (O Kα) | (N Kα) |
| Boat 1, front 1 | 100 ± 1 | 0 ± 1 | 0 ± 1 |
| Boat 1, front 2 | 100 ± 1 | 0 ± 1 | 0 ± 1 |
| Boat 1, back 1 | 100 ± 1 | 0 ± 1 | 0 ± 1 |
| Boat 1, back 2 | 100 ± 1 | 0 ± 1 | 0 ± 1 |
| Boat 2, front 1 | 99 ± 1 | 0 ± 1 | 0 ± 1 |
| Boat 2, front 2 | 99 ± 1 | 1 ± 1 | 0 ± 1 |
| Boat 2, back 1 | 99 ± 1 | 1 ± 1 | 0 ± 1 |
| Boat 2, back 2 | 99 ± 1 | 1 ± 1 | 0 ± 1 |
| Boat 3, front 1 | 99 ± 1 | 1 ± 1 | 0 ± 1 |
| Boat 3, front 2 | 100 ± 1 | 0 ± 1 | 0 ± 1 |
| Boat 3, back 1 | 95 ± 1 | 5 ± 1 | 0 ± 1 |
| Boat 3, back 2 | 93 ± 1 | 7 ± 1 | 0 ± 1 |

Method ζ, producing pure iron at 700° C. The quartz boat was charged with 0.169 g (1.06 mmol) of iron(III) oxide and loaded into the reactor. The reactor was purged with argon at 120 sccm for 5 minutes. The reactor was then heated under 120 sccm Ar at 20° C./min to 700° C., at which 5 temperature the Ar flow was stopped and a flow of 40 sccm of NH₃ was introduced. The NH₃ was supplied for a minute and then stopped, and the Ar flow of 120 sccm was resumed for 1 minute. This pulse sequence was repeated 4 more times, for a total ammonia delivery of 200 mL, distributed among the 5 pulses. The reactor was cooled under 120 sccm Ar at ca. 40° C./min. Yield: 0.122 g (expected for pure Fe: 0.118 g).

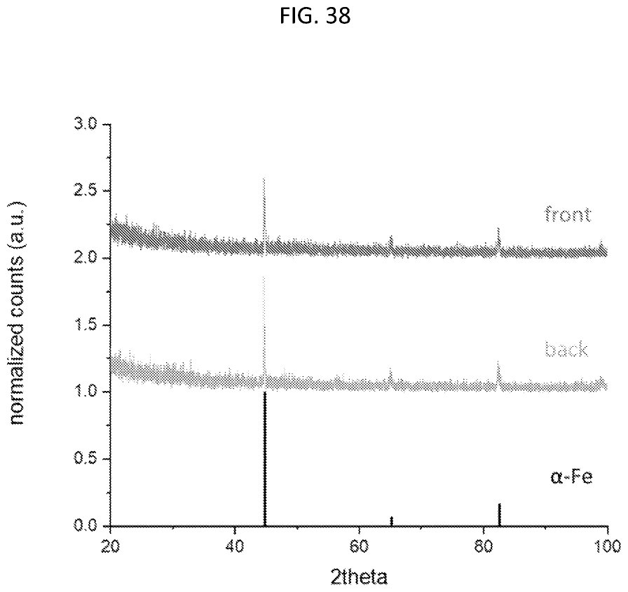

The pXRD pattern (FIG. 38) shows the crystalline product is α-Fe. EDS (Table 36) provides a composition of 97-99 at. % Fe, 0-2 at. % O, and 0-1 at. % N.

TABLE 36

| Reactor | Iron at. % | Oxygen at. % | Nitrogen at. % |
|---|---|---|---|
| Position | (Fe Kα) | (O Kα) | (N Kα) |
| Front 1 | 98.5 ± 1 | 0.5 ± 1 | 1.0 ± 1 |
| Front 2 | 99.7 ± 1 | 0.2 ± 1 | 0.1 ± 1 |
| Back 1 | 97.3 ± 1 | 0.9 ± 1 | 1.8 ± 1 |
| Back 2 | 99.1 ± 1 | 0.0 ± 1 | 0.9 ± 1 |
| Bottom 1 | 97.9 ± 1 | 0.5 ± 1 | 1.6 ± 1 |
| Bottom 2 | 97.7 ± 1 | 0.0 ± 1 | 2.3 ± 1 |
| Middle 1 | 99.3 ± 1 | 0.0 ± 1 | 0.7 ± 1 |
| Middle 2 | 99.4 ± 1 | 0.0 ± 1 | 0.6 ± 1 |

### Example 12. Reduction of Iron Oxide in the Presence of Silica, with Magnetic Separation of Reduced Iron Products and Silica

Samples of iron(III) oxide mixed with silicon dioxide (~10 to 50 wt. % silicon dioxide) were reduced at 600 or 700° C. to mixtures of reduced iron species (iron and iron nitride) and silicon dioxide. The iron-containing material was then separated from the silicon dioxide using a magnet to attract the iron or iron nitride.

Method η, producing iron and iron nitride and separating them from silicon dioxide. In a quartz boat, 0.165 g (1.03 mmol) of iron(III) oxide and 0.020 g (0.33 mmol) silicon dioxide were combined, such that the SiO₂ comprised 11 wt. % of the mixture. The quartz boat was loaded into the reactor, and the reactor was purged with argon at 120 sccm for 5 minutes. The reactor was then heated under 120 sccm Ar at 20° C./min to 600° C., at which temperature the Ar flow was stopped and a flow of 120 sccm of NH₃ was introduced. After flowing at this rate for 10 minutes, the ammonia flow was stopped and the Ar flow was resumed at 120 sccm. The reactor was cooled at ca. 40° C./min. Yield: 0.123 g (expected for pure Fe: 0.115 g)

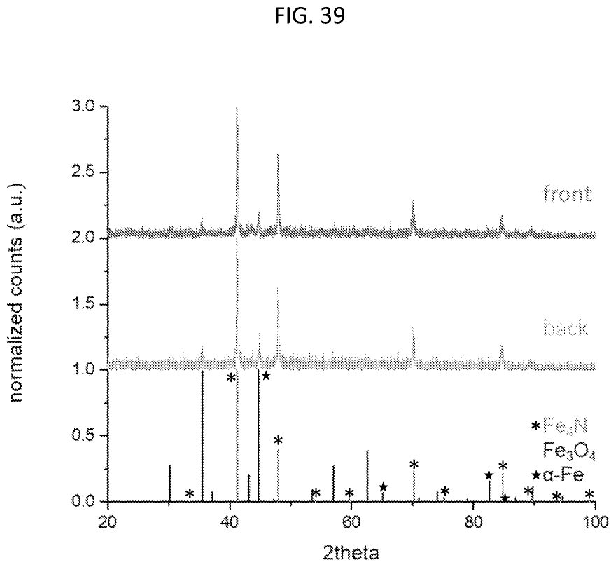

The pXRD pattern (FIG. 39) shows the crystalline product is mostly Fe and Fe₄N, with some Fe₃O₄. EDS provides a composition of 80-95 at. % Fe, 5-12 at. % O and 0-13 at. % N. Si was present at 3-26 at. % throughout the sample.

The iron nitride and silicon dioxide were separated with a Teflon-coated laboratory magnet.

Method θ, producing iron nitride and separating it from 10 wt. % silicon dioxide. In a quartz boat, 0.162 g (1.01 mmol) of iron(III) oxide and 0.018 g (0.30 mmol) of silicon dioxide were combined, such that the SiO₂ comprised 10 wt. % of the mixture. The quartz boat was loaded into the reactor, and the reactor was purged with argon at 40 sccm for 10 minutes. The reactor was then heated under 40 sccm Ar at 20° C./min to 700° C., at which temperature the Ar flow was stopped and a flow of 120 sccm of NH₃ was introduced. After flowing at this rate for 10 minutes, the ammonia flow was stopped and the Ar flow was resumed at 40 sccm. The reactor was cooled at ca. 40° C./min.

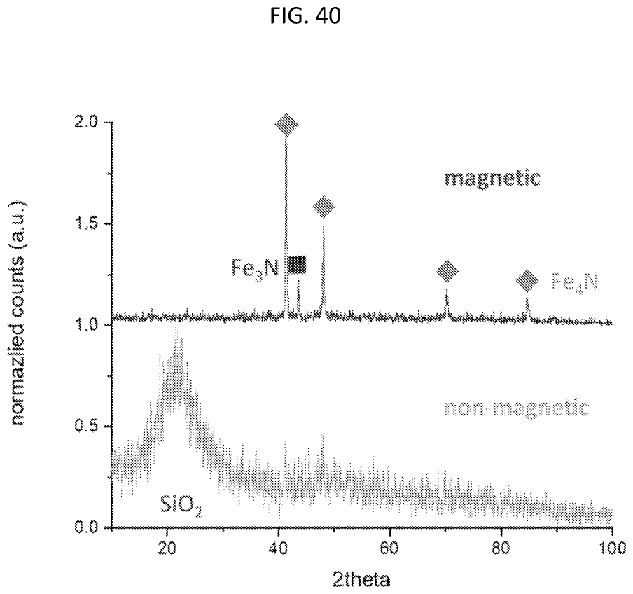

Yield: 0.116 g (expected for pure Fe: 0.113 g). The iron-containing product and silicon dioxide were separated with a magnet. 0.010 g (56%) of the SiO₂ was recovered, lowering the gangue content in the final iron product. The pXRD pattern (FIG. 40) shows the crystalline magnetic product is Fe₄N with some Fe₃N, and the non-magnetic product is weakly crystalline SiO₂.

EDS (Table 37) provides a composition for each portion of the product. The magnetic portion of the sample has a composition of 61-80 at. % Fe, 10-17 at. % O, 0-7 at. % N, and 9-15 at. % Si. The non-magnetic portion of the sample has a composition of 0-1 at. % Fe, 47-57 at. % O, 0-12 at. % N, and 40-43 at. % Si.

TABLE 37

| | Iron | Silicon | Oxygen | Nitrogen |
|---|---|---|---|---|
| Sample | at. % | at. % | at. % | at. % |
| Portion | (Fe Kα) | (Si Kα) | (O Kα) | (N Kα) |
| Magnetic 1 | 80.5 ± 1 | 9.5 ± 1 | 10.0 ± 1 | 0.0 ± 1 |
| Magnetic 2 | 60.8 ± 1 | 15.3 ± 1 | 16.8 ± 1 | 7.1 ± 1 |
| Magnetic 3 | 73.4 ± 1 | 11.0 ± 1 | 15.7 ± 1 | 0.0 ± 1 |
| Non-magnetic 1 | 0.5 ± 1 | 42.5 ± 1 | 57.0 ± 1 | 0.0 ± 1 |
| Non-magnetic 2 | 0.0 ± 1 | 43.2 ± 1 | 56.8 ± 1 | 0.0 ± 1 |
| Non-magnetic 3 | 0.1 ± 1 | 40.3 ± 1 | 47.4 ± 1 | 12.3 ± 1 |

Method ι, producing iron and separating it from silicon dioxide. In a quartz boat, 0.163 g (0.97 mmol assuming 5 wt. % gangue) of BF-grade taconite ore powder and 0.019 g (0.32 mmol) silicon dioxide were combined, such that the SiO₂ comprised 10 wt. % of the mixture. The quartz boat was loaded into the reactor, and the reactor was purged with argon at 120 sccm for 5 minutes. The reactor was then heated under 120 sccm Ar at 20° C./min to 600° C., at which temperature the Ar flow was stopped and a flow of 120 sccm of NH₃ was introduced. After flowing at this rate for 10 minutes, the ammonia flow was stopped and the Ar flow was resumed at 120 sccm. The reactor was cooled at ca. 40° C./min.

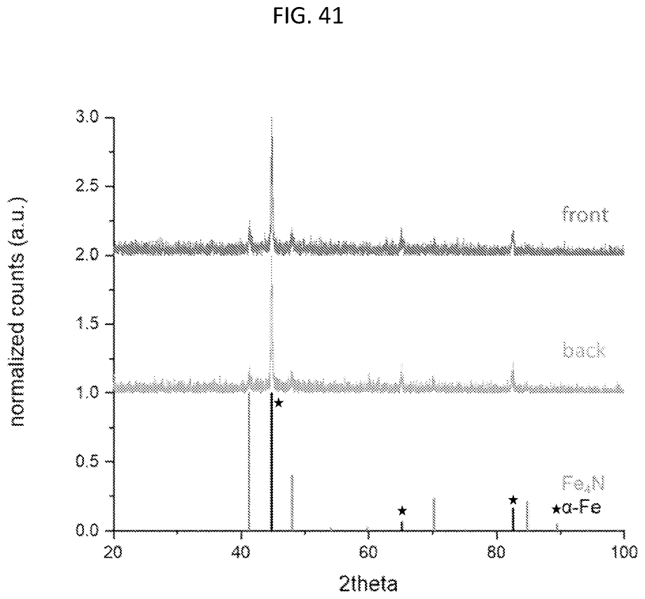

Yield: 0.0898 g (expected for pure Fe: 0.114 g). Some mechanical losses occurred while massing the product. The pXRD pattern (FIG. 41) shows the crystalline product is Fe with trace Fe₄N. EDS (Table 38) provides a composition of 57-94 at. % Fe, 3-23 at. % O and 0-1 at. % N.

The iron metal and silicon dioxide were separated with a Teflon-coated laboratory magnet. 0.011 g (56%) of the SiO₂ was recovered, lowering the gangue content in the final iron product.

TABLE 38

| Reactor | Iron at. % | Silicon at. % | Oxygen at. % | Nitrogen at. % |
|---|---|---|---|---|
| Position | (Fe Kα) | (Si Kα) | (O Kα) | (N Kα) |
| Front 1 | 93.7 ± 1 | 3.0 ± 1 | 3.3 ± 1 | 0.0 ± 1 |
| Front 2 | 75.1 ± 1 | 10.4 ± 1 | 14.1 ± 1 | 0.5 ± 1 |
| Back 1 | 68.1 ± 1 | 15.0 ± 1 | 15.9 ± 1 | 1.0 ± 1 |
| Back 2 | 89.8 ± 1 | 5.0 ± 1 | 5.3 ± 1 | 0.0 ± 1 |
| Bottom 1 | 57.1 ± 1 | 19.6 ± 1 | 23.3 ± 1 | 0.0 ± 1 |
| Bottom 2 | 76.3 ± 1 | 10.6 ± 1 | 13.1 ± 1 | 0.0 ± 1 |
| Middle 1 | 88.9 ± 1 | 4.6 ± 1 | 6.5 ± 1 | 0.0 ± 1 |
| Middle 2 | 82.9 ± 1 | 10.4 ± 1 | 6.7 ± 1 | 0.0 ± 1 |

Method κ, producing iron and separating it from 50 wt. % silicon dioxide. In a quartz boat, 0.081 g (0.51 mmol) of iron(III) oxide and 0.081 g (1.35 mmol) of silicon dioxide were combined, such that the SiO₂ comprised 50 wt. % of the mixture. The quartz boat was loaded into the reactor, and the reactor was purged with argon at 120 sccm for 5 minutes. The reactor was then heated under 120 sccm Ar at 20° C./min to 700° C., at which temperature the Ar flow was stopped and a flow of 120 sccm of NH₃ was introduced for 5 minutes. The NH₃ flow was stopped and 120 sccm Ar was introduced for 5 minutes. This pulse sequence was repeated 3 more times, for a total ammonia delivery of 2.4 L, distributed among the 4 pulses. The reactor was cooled under 120 sccm Ar at ca. 40° C./min.

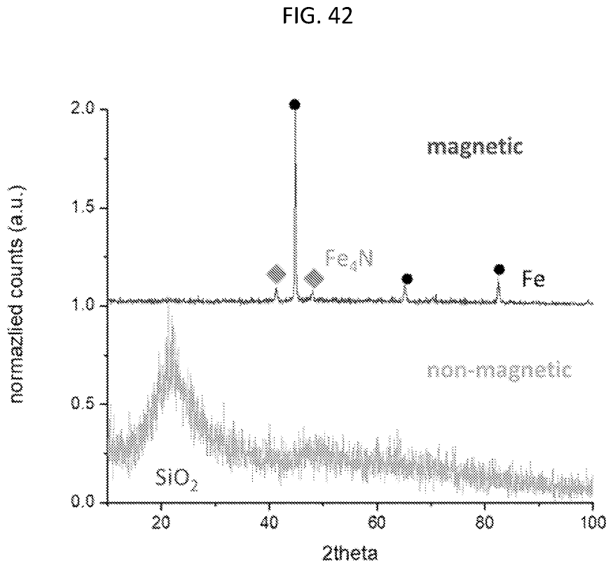

Yield: 0.104 g (expected for Fe mixed with original SiO₂: 0.138 g). The iron-containing product and silicon dioxide were separated with a magnet. 0.042 g (52%) of the SiO₂ was recovered, lowering the gangue content in the final iron product. Yield of magnetic portion: 0.042 g (expected for pure Fe: 0.057 g). The pXRD pattern (FIG. 42) shows the crystalline, magnetic product is Fe with trace Fe₄N, while the non-magnetic product is weakly crystalline SiO₂. Although EDS (below) shows that the separation of iron from gangue is not complete, the pXRD shows the iron is fully reduced to the metal.

The composition of each portion of the product was analyzed by EDS (Table 39). The magnetic portion of the sample has a composition of 30-53 at. % Fe, 23-35 at. % O, 0 at. % N, and 24-41 at. % Si. The non-magnetic portion of the sample has a composition of 0 at. % Fe, 38-55 at. % O, 0 at. % N, and 45-61 at. % Si.

TABLE 39

| | Iron | Silicon | Oxygen | Nitrogen |
|---|---|---|---|---|
| Sample | at. % | at. % | at. % | at. % |
| Portion | (Fe Kα) | (Si Kα) | (O Kα) | (N Kα) |
| Magnetic 1 | 40.7 ± 1 | 40.7 ± 1 | 29.9 ± 1 | 0.0 ± 1 |
| Magnetic 2 | 35.1 ± 1 | 31.1 ± 1 | 33.8 ± 1 | 0.0 ± 1 |
| Magnetic 3 | 52.5 ± 1 | 24.1 ± 1 | 23.4 ± 1 | 0.0 ± 1 |
| Magnetic 4 | 29.9 ± 1 | 35.5 ± 1 | 35.6 ± 1 | 0.0 ± 1 |
| Non-magnetic 1 | 0.3 ± 1 | 54.2 ± 1 | 45.5 ± 1 | 0.0 ± 1 |
| Non-magnetic 2 | 0.0 ± 1 | 51.3 ± 1 | 48.7 ± 1 | 0.0 ± 1 |
| Non-magnetic 3 | 0.1 ± 1 | 44.7 ± 1 | 55.2 ± 1 | 0.0 ± 1 |
| Non-magnetic 4 | 0.1 ± 1 | 61.4 ± 1 | 38.4 ± 1 | 0.0 ± 1 |

### Example 13. Reduction of Iron Oxides with Mixtures of Ammonia and Hydrogen

Mixtures of ammonia and hydrogen can be used to reduce iron oxide samples, with similar results to pure ammonia. Use of hydrogen slows the reduction in comparison to ammonia alone.

Method λ, producing Fe₃N at 700° C. from a 3:1 mixture of ammonia: hydrogen. The quartz boat was charged with 0.237 g (1.02 mmol) iron(II,III) oxide and loaded into the reactor. The reactor was purged with argon at 40 sccm for 10 minutes. The reactor was then heated under 40 sccm Ar at 20° C./min to 700° C., at which temperature the Ar flow was stopped and a flow of 30 sccm of NH₃ and 10 sccm of H₂ was introduced. After flowing at this rate for 10 minutes, the ammonia and hydrogen flows were stopped and the Ar flow was resumed at 40 sccm. The reactor was cooled at ca. 40° C./min. Yield: 0.176 g (expected for pure Fe: 0.171 g; expected for pure Fe₃N: 0.186 g).

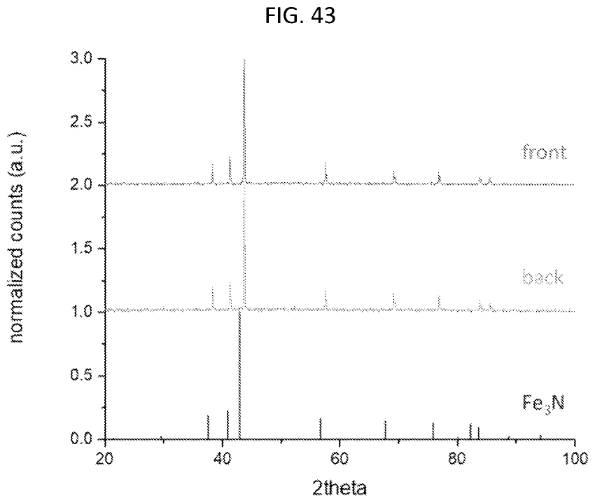

The pXRD pattern (FIG. 43) shows the crystalline product is ε-Fe₃N. EDS (Table 40) provides a composition of 93-98 at. % Fe, 0 at. % O, and 2-6 at. % N. Elemental microanalysis by combustion indicates 7.6±0.4 wt. % N (expected for Fe₃N: 7.7 wt. % N).

TABLE 40

| Reactor | Iron at. % | Oxygen at. % | Nitrogen at. % |
|---|---|---|---|
| Position | (Fe Kα) | (O Kα) | (N Kα) |
| Front 1 | 93.2 ± 1 | 0.4 ± 1 | 6.4 ± 1 |
| Front 2 | 96.4 ± 1 | 0.5 ± 1 | 5.6 ± 1 |
| Back 1 | 97.1 ± 1 | 0.1 ± 1 | 2.8 ± 1 |
| Back 2 | 96.4 ± 1 | 0.4 ± 1 | 3.2 ± 1 |
| Bottom 1 | 97.7 ± 1 | 0.4 ± 1 | 1.9 ± 1 |
| Bottom 2 | 94.2 ± 1 | 0.3 ± 1 | 5.5 ± 1 |
| Middle 1 | 97.8 ± 1 | 0.2 ± 1 | 2.0 ± 1 |
| Middle 2 | 97.3 ± 1 | 0.0 ± 1 | 2.7 ± 1 |

Method μ, producing iron at 700° C. from a 3:1 mixture of ammonia: hydrogen. The quartz boat was charged with 0.164 g (1.03 mmol) iron(III) oxide and loaded into the reactor. The reactor was purged with argon at 40 sccm for 10 minutes. The reactor was then heated under 40 sccm Ar at 20° C./min to 700° C., at which temperature the Ar flow was stopped and a flow of 30 sccm of NH₃ and 10 sccm of H₂ was introduced. After flowing at this rate for 10 minutes, the ammonia and hydrogen flows were stopped and the Ar flow was resumed at 40 sccm. The reactor was cooled at ca. 40° C./min. Yield: 0.119 g (expected for pure Fe: 0.115 g)

The pXRD pattern (FIG. 44) shows the crystalline product is Fe with some Fe₄N. EDS (Table 41) provides a composition of 93-99 at. % Fe, 1-2 at. % O, and 0-5 at. % N.

TABLE 41

| Reactor | Iron at. % | Oxygen at. % | Nitrogen at. % |
|---|---|---|---|
| Position | (Fe Kα) | (O Kα) | (N Kα) |
| Front 1 | 92.8 ± 1 | 1.9 ± 1 | 5.3 ± 1 |
| Front 2 | 99.1 ± 1 | 1.0 ± 1 | 1.0 ± 1 |
| Back 1 | 99.3 ± 1 | 0.8 ± 1 | 0.0 ± 1 |
| Back 2 | 99.0 ± 1 | 1.0 ± 1 | 0.0 ± 1 |
| Bottom 1 | 98.4 ± 1 | 1.0 ± 1 | 0.6 ± 1 |
| Bottom 2 | 97.1 ± 1 | 2.0 ± 1 | 1.0 ± 1 |
| Middle 1 | 97.3 ± 1 | 2.0 ± 1 | 0.6 ± 1 |
| Middle 2 | 98.5 ± 1 | 1.1 ± 1 | 0.4 ± 1 |

### Example 14: Simultaneous Reduction of Iron Oxide and Nickel Oxide

Ammonia can be used to reduce mixtures of iron oxide and nickel oxide. The resulting iron-nickel mixture could be used in making stainless steels.

Method ν, producing iron and nickel at 700° C. In a quartz boat, 0.141 g (0.88 mmol) of iron(III) oxide and 0.018 g (0.24 mmol) of nickel(II) oxide were combined, such that after complete reduction, the Ni would comprise 12.5 wt. % of the mixture. The quartz boat was loaded into the reactor, and the reactor was purged with argon at 120 sccm for 10 minutes. The reactor was then heated under 120 sccm Ar at 20° C./min to 700° C., at which temperature the Ar flow was stopped and a flow of 120 sccm of NH₃ was introduced. After flowing at this rate for 10 minutes, the ammonia flow was stopped and the Ar flow was resumed at 120 sccm. The reactor was cooled at ca. 40° C./min.

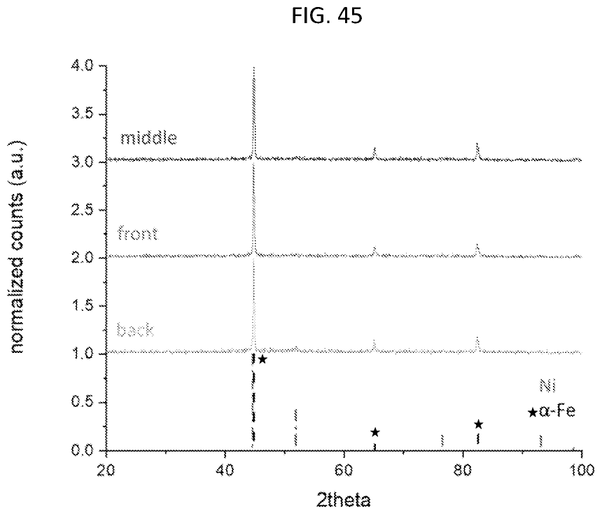

Yield: 0.109 g (expected for pure Fe/Ni: 0.112 g). The pXRD pattern (FIG. 45) shows the crystalline product comprises Fe and Ni. EDS (Table 42) provides a composition of 92-99 at. % Fe, 0-4 at. % Ni, 0-2 at. % O, and 0-3 at. % N.

TABLE 42

| Sample | Iron at. % | Nickel at. % | Oxygen at. % | Nitrogen at. % |
|---|---|---|---|---|
| Location | (Fe Kα) | (Ni Kα) | (O Kα) | (N Kα) |
| 1a | 92.2 ± 1 | 3.2 ± 1 | 1.8 ± 1 | 3.2 ± 1 |
| 1b | 97.9 ± 1 | 0.0 ± 1 | 1.3 ± 1 | 0.8 ± 1 |
| 2a | 98.3 ± 1 | 1.3 ± 1 | 0.1 ± 1 | 0.4 ± 1 |
| 2b | 98.1 ± 1 | 1.8 ± 1 | 0.0 ± 1 | 0.2 ± 1 |
| 3a (bottom) | 98.1 ± 1 | 1.2 ± 1 | 0.7 ± 1 | 0.0 ± 1 |
| 3b (bottom) | 99.2 ± 1 | 0.1 ± 1 | 0.6 ± 1 | 0.2 ± 1 |
| 3a (top) | 95.3 ± 1 | 4.2 ± 1 | 0.5 ± 1 | 0.0 ± 1 |
| 3b (top) | 95.6 ± 1 | 2.7 ± 1 | 0.8 ± 1 | 0.9 ± 1 |

### REFERENCES

1. Hosokai, S.; Kasiwaya, Y.; Matsui, K.; Okinaka, N.; Akiyama, T., Ironmaking with Ammonia at Low Temperature. Environmental Science and Technology 2011, 45, 821-826.
2. Yasuda, N.; Mochizuki, Y.; Tsubouchi, N.; Akiyama, T., Reduction and Nitriding Behavior of Hematite with Ammonia. ISIJ International 2015, 55, 736-741.
3. Ma, Y.; Bae, J. W.; Kim, S.-H.; Jovičević-Klug, M.; Li, K.; Vogel, D.; Ponge, D.; Rohwerder, M.; Gault, B.; Raabe, D., Reducing Iron Oxide with Ammonia: A Sustainable Path to Green Steel. Advanced Science 2023, (online in advance of print), 2300111.
4. Chatterjee, A., Sponge Iron Production by Direct Reduction of Iron Oxide. 2^{nd} ed.; PHI Learning Private Limited: Delhi, India, 2012.
5. Parisi, D. R.; Laborde, M. A., Modeling of counter current moving bed gas-solid reactor used in direct reduction of iron ore. Chem. Eng. J. 2004, 104, 35-43.
6. Direct from Midrex: 2^{nd} Quarter 2019; 2019.
7. Oudiz, J. J., Poling processes for copper refining. Journal of Metals 1973, 25, 35-38.
8. Steel Statistical Yearbook: 2020 concise version; World Steel Association: Brussels, Belgium, 2020.
9. Fan, Z.; Friedman, S. J., Low-carbon production of iron and steel: Technology options, economic assessment, and policy. Joule 2021, 5, 1-34.
10. Dana, A. G.; Elishav, O.; Bardow, A.; Shter, G. E.; Grader, G. S., Nitrogen-Based Fuels: A Power-to-Fuel-to-Power Analysis. Angewandte Chemie International Edition 2016, 55, 8798-8805.
11. The Future of Hydrogen: Seizing today's opportunities; International Energy Agency: 2019.
12. Zhao, Y.; Setzler, B. P.; Wang, J.; Nash, J.; Wang, T.; Xu, B.; Yan, Y., An Efficient Direct Ammonia Fuel Cell for Affordable Carbon-Neutral Transportation. Joule 2019, 3, 2472-2484.
13. Sampson, J., Origin Energy, POSCO ink green hydrogen deal H2-view Mar. 18, 2021, https://www.h2-view.com/story/origin-energy-posco-ink-green-hydrogen-deal/.
14. Akiyama, T.; Okinaka, N.; Hosokai, S.; Matsui, K. Ironmaking process and ironmaking system. WO/2011/108570, JP2011179089, and IN8085/CHENP/2012, 2011.
15. Wu, Y.-D.; Zhang, G.-H.; Chou, K.-C., Preparation of High-Quality FeV55N Using Ammonia as a Reductant and Nitrogen Source. Journal of Metals 2018, 70, 2493-2498.
16. Liu, Y.; Wang, Y.; You, Z.; Lv, X., Reduction and Nitridation of Iron/Vanadium Oxides by Ammonia Gas: Mechanism and Preparation of FeV45N Alloy. Metals 2020, 10, 356.
17. Liu, Y.; Xin, R.; Ma, D.; Hu, Q.; Wang, Y.; You, Z., Behavior of synchronous reduction and nitridation of iron/vanadium oxides with NH₃-H₂ mixtures. Journal of Materials Research and Technology 2021, 15, 5046-5058.
18. Dam, O., Effect of the decomposition of ammonia gas (NH₃) on the swelling of iron oxides during reduction. Athenea Journal in Engineering Sciences 2020, 1, 5-11.
19. Dam, O.; Azócar, L., Effect of the reaction of ammonia gas on the swelling of metallic iron and its oxides during nitriding processes. Athenea Journal in Engineering Sciences 2021, 2, 38-45.

We claim:

1. A method for reducing a metal oxide, the method comprising contacting a metal oxide with a reducing gas comprising primarily ammonia for a reduction time at a reduction temperature, wherein ammonia contacting the metal oxide reduces the metal oxide.

2. The method of claim 1, wherein a purge gas is introduced for one or more intervals during the reduction time.

3. The method of claim 2, wherein the purge gas comprises argon or nitrogen.

4. The method of any one of claims 1-3, wherein the amount of ammonia contacted with the metal oxide is effective in reducing at least 50% of the metal oxide to metal or metal nitride.

5. The method of claim 4, wherein the amount of ammonia contacted with the metal oxide is between 2 and 50 moles of ammonia per mole of metal oxide.

6. The method of any one of claims 1-3, wherein the reducing gas is substantially ammonia.

7. The method of any one of claims 1-3, wherein the reducing gas further comprises hydrogen.

8. The method of any one of claims 1-3, wherein the reduction temperature is between 300° C. and 1600° C.

9. The method of any one of claims 1-3, wherein the reduction temperature is between 600° C. and 1000° C.

10. The method of any one of claims 1-3, wherein the metal oxide is selected from an iron oxide, nickel oxide, cobalt oxide, tungsten oxide, tin oxide, zinc oxide, copper oxide, and any combination thereof.

11. The method of any one of claims 1-3, wherein the metal oxide is an iron oxide.

12. The method of any one of claims 1-3, wherein the metal oxide is Fe₂O₃, Fe₃O₄, FeO, FeO(OH), or any combination thereof.

13. The method of any one of claims 1-3, wherein an ore comprising the metal oxide is reduced.

14. The method of claim 13, wherein the ore comprises hematite, wustite, magnetite, or goethite.

15. The method of claim 14, wherein the ore further comprises more than 10% gangue by weight.

16. The method of claim 15, wherein the gangue comprises silicon dioxide or aluminum oxide.

17. The method of claim 13 further comprising separating the reduced metal oxide from gangue.

18. The method of claim 17, wherein the reduced metal oxide is magnetic, wherein at least a portion of the gangue is non-magnetic, and wherein the reduced metal oxide is magnetically separated from the gangue.

19. The method of any one of claims 1-3, wherein the reduction time is between 1 min and 24 hours.

20. The method of claim 19, wherein the reduction time is between 1 min and 60 min.

21. The method of any one of claims 1-3, further comprising
heating the interior of a reactor to the reduction temperature prior to contacting the metal oxide with the reducing gas for the reduction time at the reduction temperature, and
introducing a cooling gas into the interior of the reactor after contacting a metal oxide with the reducing gas for the reduction time at the reduction temperature.

22. The method of claim 21, wherein the reactor has an ammonia decomposition catalyst therein and introducing the reducing gas into the interior of the reactor generates hydrogen in situ.

23. The method of claim 21, wherein an inert gas is introduced into the interior of the reactor during heating of the reactor.

24. The method of claim 23, wherein the inert gas comprises argon or nitrogen.

25. The method of claim 21, wherein the cooling gas comprises argon or nitrogen.

26. The method of claim 21, wherein the reducing gas is introduced into the interior of the reactor at a rate of between 40 sccm and 4,000,000 slm.

27. The method of claim 21, wherein the cooling gas is introduced at a rate of between 40 sccm and 20,000,000 slm.

28. The method of claim 23, wherein the inert gas is introduced into the reactor during heating at a rate of between 40 sccm and 4,000,000 slm.

29. The method of claim 21, wherein the purge gas is introduced into the reactor a rate of between 40 sccm and 20,000,000 slm.

30. The method of any claim 21, wherein the amount of water within the interior of the reactor during or at the conclusion of the reduction time is less than 1.5 moles per mole of metal.

31. The method of claim 21, wherein the partial pressure of water within the interior of the reactor is less than 220 Torr when reduction is performed at 760 Torr.
